(19) United States
(12) Patent Application Publication
(10) Pub. No.: US 2025/0302586 A1
(43) Pub. Date: Oct. 2, 2025

(54) ASSEMBLIES, SYSTEMS, AND DEVICES FOR DENTAL PROCEDURES

(71) Applicant: Octodent LLC, Mountain Home, AR (US)

(72) Inventors: Chad E. Jensen, Hollister, MO (US); Daniel P. Servansky, Pittsburgh, PA (US); Courtney R. Schwiebert, Huntertown, IN (US)

(21) Appl. No.: 18/620,229

(22) Filed: Mar. 28, 2024

(51) Int. Cl. A61C 5/85; A61C 5/88

(52) U.S. Cl. CPC A61C 5/85; A61C 5/88

(57) ABSTRACT

Dental procedure devices and assemblies are disclosed. The dental procedure device can comprise a body including a matrix with an inner matrix surface, and a lower member providing a wedge shape and an inner surface that extends from a bottom portion of the inner matrix surface, wherein a dimension of the inner surface of the lower member gradually increases along a length of the lower member to provide a downward protruding portion. The dental procedure device can further comprise a handle connected to the body at a first end of the body and extending from the body. The lower member can at least partially form a tapered lead in portion at a second end of the body opposite the first end of the body coupled to the handle. The lead in can be configured to facilitate positioning of the dental procedure device.

### TECHNICAL FIELD

The present disclosure relates generally to the field of dental procedures. More specifically, the present disclosure relates to assemblies and systems for performing direct restoration dental procedures.

### SUMMARY

Disclosed herein are devices, assemblies, and systems for use in performing direct restoration dental procedures, including to contact a tooth to be treated and to control, shape, and/or confine restorative materials during a dental procedure. The features, structures, steps, or characteristics disclosed herein in connection with one embodiment may be combined in any suitable manner in one or more alternative embodiments.

### BRIEF DESCRIPTION OF THE FIGURES

Non-limiting and non-exhaustive embodiments of the disclosure are described, including various embodiments of the disclosure with reference to the following figures.

FIG. 1A is a front view of a dental procedure device, according to some embodiments.

FIG. 1B is a bottoms view of a dental procedure device, according to some embodiments.

FIG. 1C is a top view of a dental procedure device, according to some embodiments.

FIG. 1D is a cross section view of a dental procedure device, according to some embodiments.

FIG. 1E is a perspective view of a dental procedure device, according to some embodiments.

FIG. 2 is a top view of a dental procedure device inserted between two teeth, according to some embodiments.

FIG. 3 is a top view of a dental procedure device inserted between two teeth, according to some embodiments.

FIG. 4 is a bottom view of a dental procedure device with a straight tip, according to some embodiments.

FIG. 5 is a front view of a dental procedure device, according to some embodiments.

FIG. 6 is a front view of a dental procedure device, according to some embodiments.

FIG. 7 is a front view of a dental procedure device, according to some embodiments.

FIG. 8 is a front view of a dental procedure device, according to some embodiments.

FIG. 9 is a top view of a dental procedure device, according to some embodiments.

FIG. 10 is a cross section view of a dental procedure device, according to some embodiments.

### DETAILED DESCRIPTION

Dental restorations are a familiar process performed in dental settings by practitioners. During dental restorations a practitioner may use a matrix or multiple matrices and one or more dental wedges to seal, confine, shape, and support restoration material during the dental procedure (e.g., retain one or more dental filling materials within a restoration area and in a contoured shape). In other embodiments, the dental procedure device can provide a contoured surface and may be configured to form and retain restorative materials for the direct restoration of a tooth. In some examples, the dental procedure device can be shaped to create a seal between a tooth to be treated and/or restored and the dental procedure device. For example, the dental procedure device can include a lower member, a matrix, and an upper member, which may each be shaped to provide a structural contoured surface, which may be sealed to a portion of the tooth to be treated, during a dental procedure.

Embodiments herein describe assemblies, devices, and systems to assist in dental procedures, such as a procedure to restore a portion of a tooth with one or more restorative materials. A dental procedure device can comprise a body, which can further include a matrix with an inner matrix surface, and a lower member providing a wedge shape and an inner surface that extends from a bottom portion of the inner matrix surface. In some embodiments of the dental procedure device, a dimension of the inner surface of the lower member can gradually increase (e.g., expand at a bottom edge) along a length of the lower member and may provide a downward protruding portion. And in some embodiments the dental procedure device may further include a handle connected to the body at a first end of the body and which extends laterally away from the body. Additionally, in some embodiments of a dental procedure device, the lower member can at least partially form a tapered lead in portion at a second end of the body opposite the first end of the body coupled to the handle. Further, in some embodiments, the lead in portion may be configured to facilitate positioning and/or insertion of the dental procedure device between and/or adjacent to one or more teeth.

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The phrase “coupled to” is used in its ordinary sense and is broad enough to refer to any suitable coupling or other form of interaction between two or more entities, including mechanical, fluid, and thermal interaction. Two components may be coupled to each other even though they are not in direct contact with each other.

The terms “longitudinal” and “longitudinally” refer to a direction or orientation that is horizontal, such as in a lingual to buccal direction or vice versa.

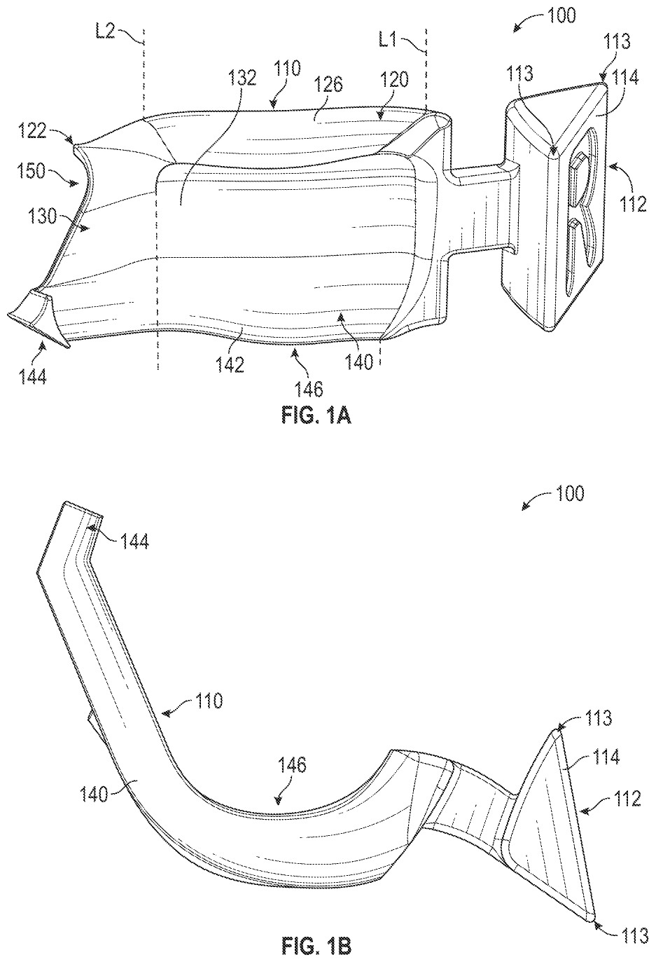

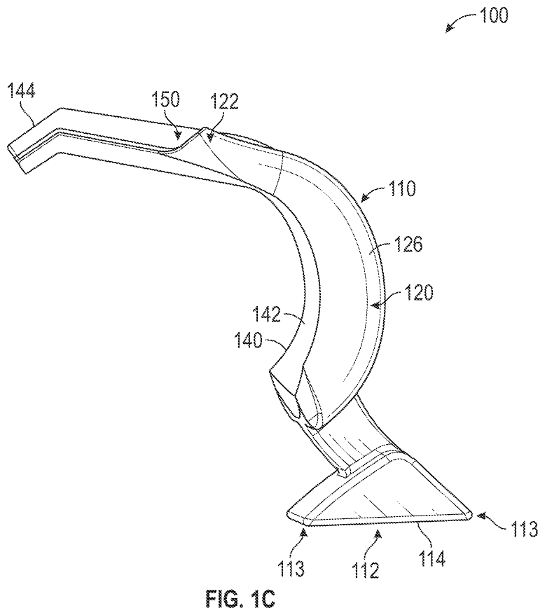

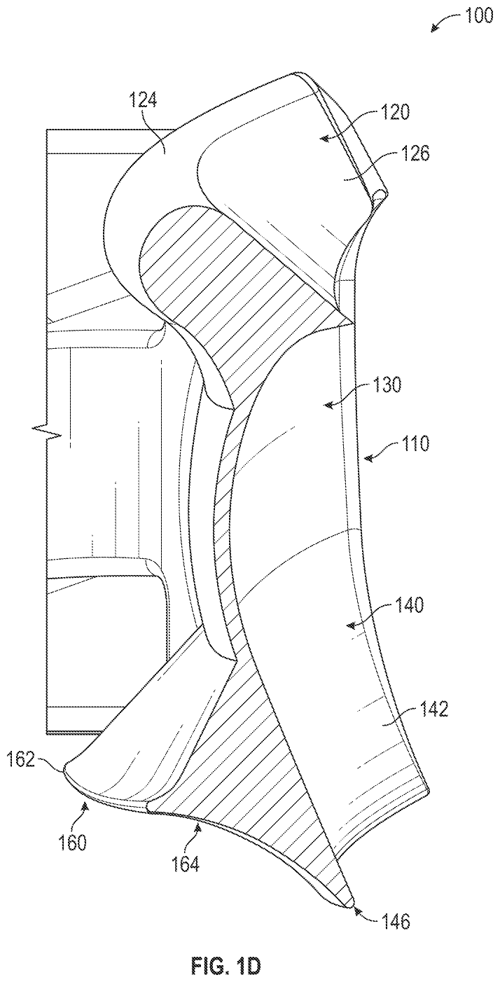

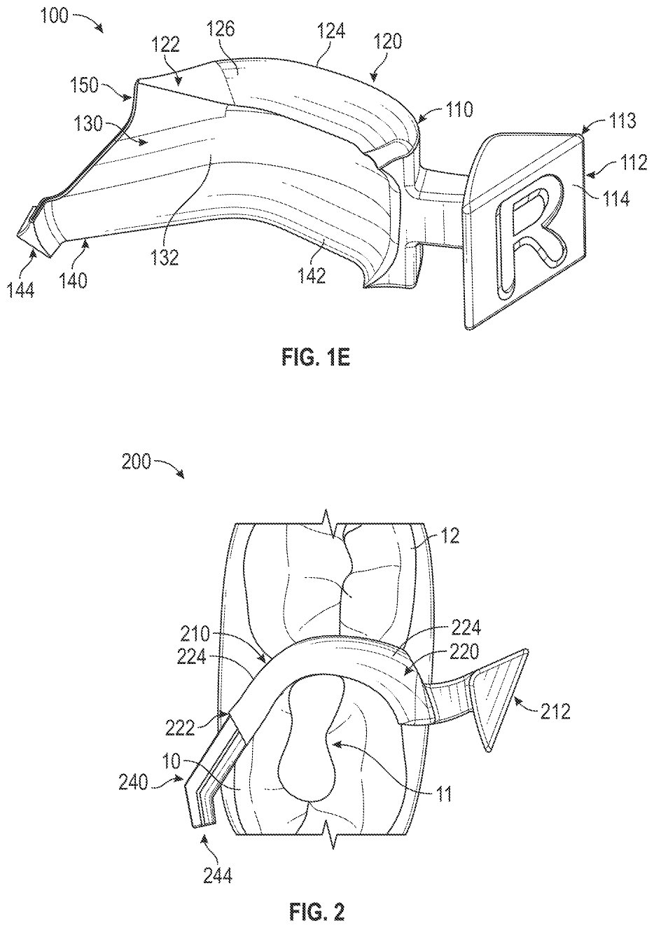

FIG. 1A is a front view of a dental procedure device 100, according to some embodiments. The dental procedure device 100 can include a body 110 and a handle 112 coupled (e.g., physically connected) to the body 110. The body 110 of the dental procedure device 100 can include an upper member 120, a matrix 130, and a lower member 140. Additionally, the upper member 120 can include an upper wedge portion 122 and an upper surface 126. The upper wedge portion 122 can be formed to angle away from the upper surface 126 of the upper member 120 (e.g., as described in greater detail below, with reference to FIG. 1D). The matrix 130 can include an inner matrix surface 132. Additionally, the lower member 140 can include an inner surface 142, a lead in portion 144 (also referred to herein as an insertion tip 144 and/or an insertion member 144), and a downward protruding edge 146.

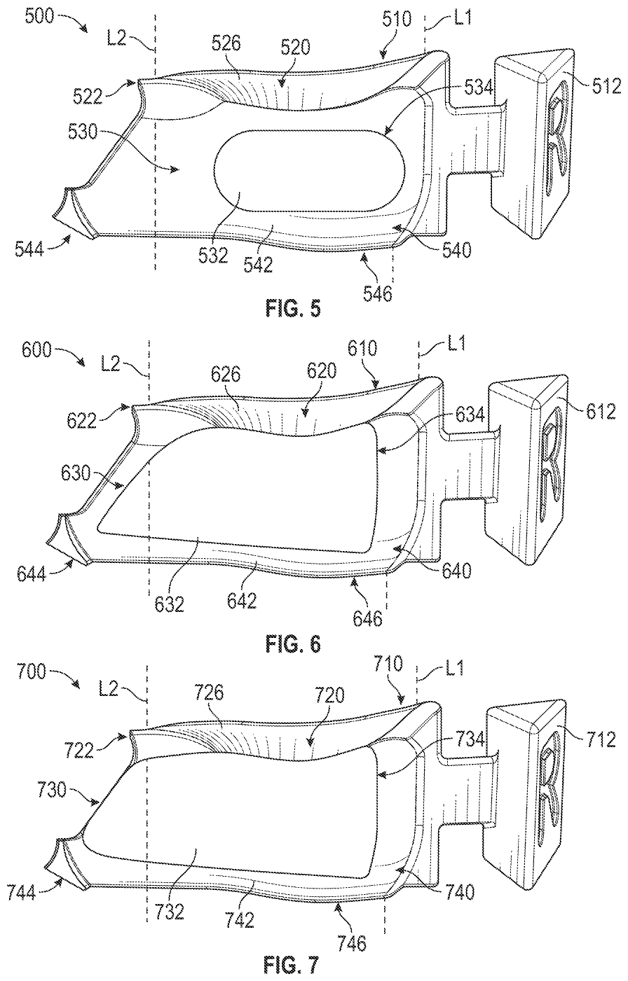

In some examples, the body 110 and the handle 112 can be formed from the same material (e.g., a single continuous material), such as a single polymer material. However, in some examples, the body 110, or one or more portions thereof, and/or the handle 112 may be formed from one or more different materials (e.g., one or more different polymers, one or more metals and/or metal alloys, and the like), as described below in greater detail with reference to FIGS. 5-7.

In some embodiments, the handle 112 can include a handle formed with a different shape, size, and/or orientation from the handle 112 shown in FIG. 1A. For example, the handle 112 can extend away from the body 110 of the dental procedure device 100 at a variety of different angles, or at no angle at all (e.g., formed physically in-line with the body 110).

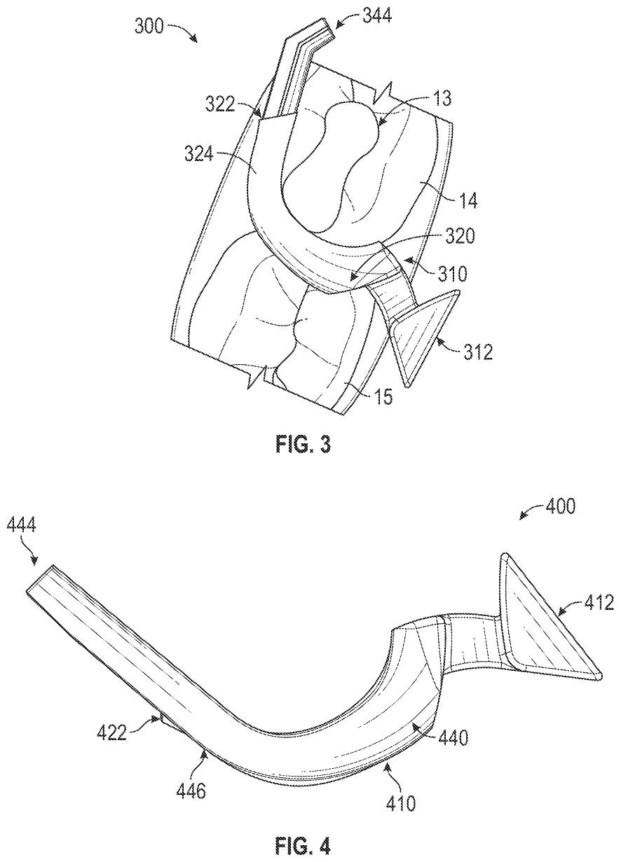

In some embodiments, the dental procedure device 100 can be configured to be inserted from the buccal side of a tooth to the lingual side of the tooth to restore a mesial portion of the tooth (e.g., a portion of the tooth disposed closer to a front of a mouth, such as shown in FIG. 3). However, in one or more other embodiments, the dental procedure device 100 can be configured to be inserted from the buccal side of a tooth to the lingual side to restore a distal portion of the tooth (e.g., a portion of the tooth disposed further from a front of a mouth, such as shown in FIG. 2). Additionally, in some examples, the handle 112 can extend from the body 110 at an angle based on the contours of the upper member 120, the matrix 130, and/or the lower member 140.

For example, the handle 112 may extend away from the body 110 at a first angle for a dental procedure device 100 to be inserted from a lingual side of a tooth and toward a buccal side. In some embodiments, the first angle of the handle 112 can be an obtuse angle (e.g., with respect to the body 110). Alternatively, in some examples the handle 112 may extend away at a second angle (e.g., an angle opposite the first angle) for a dental procedure device configured for insertion in the opposite direction, that is from a buccal side of a tooth to a lingual side. However, the handle 112 can extend away from the body 110 with any orientation, size, or shape and is not limited to the specific example shown in FIG. 1A (e.g., an obtuse angle, an acute angle, or without an angle and/or in a parallel orientation with respect to the body 110).

The handle 112 can include one or more pivot points 113 to facilitate gripping the handle 112 by a user (e.g., a dentist, a hygienist, dental technician, other dental clinician) and/or to facilitate manipulation of the handle 112 by one or more fingers of a user. Additionally, the handle 112 can include one or more pushing surfaces 114 (e.g., one or more planar portions) that are configured to receive, and/or facilitate application of, a pushing force from or by a user or device held by a user. Stated differently, the handle 112 can include the one or more pushing surfaces 114 to facilitate an application of a force to the dental procedure device 100 via the pushing surface 114, which may be a force applied in a tangential and/or longitudinal direction (e.g., lingual to buccal or vice versa), instead of a vertically applied force. The pushing surface 114 can be configured (e.g., sized and/or shaped) to assist in installing and/or positioning the dental procedure device 100 between adjacent teeth before performing (or during) a dental procedure.

Additionally, the handle 112 can include one or more physical features (e.g., shapes, edges, protrusions, recesses, etc.) that may be configured to receive a portion of dental floss, which may be wrapped around the handle 112 and used to prevent and/or reduce instances of a user accidentally dropping the dental procedure device 100. Similarly, the handle 112 can include one or more physical features (e.g., shapes, edges, protrusions, recesses, etc.) that are configured to facilitate the use of one or more tools (e.g., cotton pliers, hemostats, dental explorer, etc.) to insert, position, retain, and/or remove the dental procedure device 100. For example, the handle 112 can include a rectangular shape with a plurality of edges and/or pivot points 113 that may be gripped by a pair of cotton pliers or other dental instrument to aid in insertion, positioning, retention, and/or removal of the dental procedure device 100 between adjacent teeth (e.g., to insert the device 100 as shown in, and described in greater detail below with reference to, FIGS. 2 and 3).

In some examples, the handle 112 can include one or more curved surfaces configured to physically engage, or come into physical contact with, one of two adjacent teeth with the dental procedure device inserted between them. Stated differently, the handle 112 can include one or more curved surfaces to enable the handle 112 to be rotated and/or positioned to abut a tooth that is adjacent to a tooth designated for a dental procedure (e.g., to enable the handle 212 to abut the tooth 12 shown in FIG. 2).

Further, the handle 112 can physically connect to, and/or couple with, a portion of the body that can include the upper member 120 and/or the lower member 140 and/or matrix 130 to prevent unwanted twisting, torsion, and/or flattening of the matrix 130, the upper member 120, and/or the lower member 140. Accordingly, the handle 112, the upper member 120, and the lower member 140, can provide physical support to, and may prevent substantial physical deformation of, the matrix 130 after insertion of the dental procedure device 100 between two adjacent teeth.

In other embodiments, the upper member 120 and/or the lower member 140 can couple and/or physically connect to one or more handles 112. Coupling with the upper member 120 and lower member 140 promotes the upper member, lower member, and matrix 130 to move, flex, and/or twist independently from one another. This independency allows for the upper member 120 and lower member 140, to seal with the tooth to be restored at a buccal region and at a lingual region to prevent (or inhibit) saliva, blood, or other contaminants from entering a restoration area and/or to contain one or more dental materials used during a dental procedure. Additionally, independent movement of these elements allows for proper conformance to the natural subgingival tooth anatomy, contact surface, and the mesial marginal ridge.

The handle 112 can include one or more visual indicators of an orientation associated with the dental procedure device 100 (e.g., for a dental procedure device 100 configured to be inserted with different orientations, as described in greater detail below). For example, a dental procedure device 100 can be configured for insertion from buccal to lingual, or vice versa, (e.g., for a dental procedure to be performed on a dental cavity and on one or more tooth surfaces requiring restoration including, but not limited to, a proximal surface, or subgingival anatomy of a tooth, as shown in FIG. 2) and may include an “R” formed in one or more surfaces of the handle 112. Alternatively, a dental procedure device 100 can be configured for insertion from lingual to buccal, or vice versa, (e.g., for a dental procedure to be performed on a dental cavity and on one or more tooth surfaces requiring restoration including, but not limited to, a proximal surface, or subgingival anatomy of a tooth, as shown in FIG. 3) and may include an “L” formed in, or displayed on, one or more surfaces of the handle 112 (e.g., the pushing surface 114). Accordingly, in some examples, the handle 112 can include an imprint of one or more of an “L”, an “R”, and/or one or more directional arrows in one or more surfaces of the handle 112 (e.g., the pushing surface 114).

As described above, the body 110 of the dental procedure device 100 can include an upper member 120, a matrix 130, and a lower member 140. As mentioned previously, the different portions of the body 110 can all be formed from a single material, such as a single continuous polymer. However, in some examples, the body 110 can include one or more components formed of one or more different materials. For example, the upper and/or lower members 120, 140 of the body 110 may each be formed from a polymer material that is physically formed around a metal material that forms at least a portion of the matrix 130 (e.g., as described in greater detail below, with reference to FIGS. 5-7.)

In some examples, the upper member 120 can be formed with a cross-sectional area configured to support one or more natural contours in a marginal ridge of a tooth during a dental procedure. Additionally, the upper member 120 can include an upper wedge portion 122 and an upper surface 126. The upper wedge portion 122 can be formed to angle away from the upper surface 126 of the upper member 120, such as at an obtuse angle with respect to the matrix 130 (e.g., as described in greater detail below, with reference to FIG. 1E). In some embodiments, the upper wedge portion 122 may be shaped to provide support and structure (e.g., an amount of physical rigidity without an undesirable reduction in flexibility) to the matrix 130, including after insertion of the dental procedure device 100 and/or during a dental procedure (e.g., a dental restoration).

Additionally, in some embodiments, the upper wedge portion 122 can provide a clamping force between the upper member 120 and a tooth to be restored during a dental procedure. More specifically, the upper wedge portion 122 can be shaped to abut, or physically contact, an adjacent tooth and cause the upper member 120 and/or matrix 130 to seal with the tooth to be restored at a buccal region and at a lingual region to prevent (or inhibit) saliva, blood or other contaminants from entering a restoration area and/or to contain one or more dental materials used during a dental procedure.

In other embodiments, the upper member 120 and the upper wedge portion 122 can each be formed in one or more of a variety of acceptable shapes and need not be limited to the specific examples shown in the figures. For example, the upper member may be shaped with a cross section that is triangular, rectangular, T-Shaped, W-shaped, Y-shaped, V-shaped, U shaped, circular, semi-circular, or polygonal. In addition, it may be rail shaped, split designed, fan shaped, wafer designed, honeycombed, wavy, beaded, chained, segmented, interrupted, hollow, solid, or filled. The shape may change direction, size and may utilize several shapes.

The upper surface 126 can further be shaped to angle away from the inner matrix surface 132, and the surface of a tooth, which may facilitate physical access to a tooth to be restored, including, for example, a proximal box during a dental procedure. For example, the upper surface 126 and/or the upper protrusion 124 can include a shape and/or size that are configured to facilitate shaping of a dental composite, or restoration material, and to facilitate access by a user to the tooth from one or more different angles (e.g., allow user access to the proximal box and/or shape the restorative material from one or more different angles), during a dental procedure. The upper surface 126 can extend over some or all of the occlusal surface and may include geometry or features for restoration of the occlusal surface.

In some embodiments, at least a portion of the upper member 120 and/or the upper protrusion 124 can extend away from a tooth and/or the inner matrix surface 132 with a curved and/or contoured shape (e.g., a ‘dog-ear’ shape or outward curve), referred to herein as a curved extension 150. The curved extension 150 may be, and/or include, one or more portions of the upper member 120 and/or matrix 130, that curves away from the tooth to receive the dental procedure device and/or inner matrix surface 132 and may be configured to facilitate the insertion of the dental procedure device 100 between two adjacent teeth (e.g., as shown in FIGS. 2 and 3). The curved extension 150 can be configured to facilitate and/or allow the device 100 to traverse a proximal box of a tooth during insertion of the device 100. In some embodiments, the curved extension 150 can include a portion of the upper member 120, upper wedge 122, upper protrusion 124 and/or of the matrix 130, which may be disposed to the left of the line L2. In another example, the curved extension 150 can include and/or be formed by the portion of the upper member 120, upper wedge 122, upper protrusion 124 and/or of the matrix 130 disposed to the left of a region located between the lines L2 and L1. In still other examples, the curved extension 150 can include the portion of the upper member 120, upper wedge 122, upper protrusion 124 and/or of the matrix 130 that is disposed to the left of the line L1

The matrix 130 can include an inner matrix surface 132. In some examples, the inner matrix surface 132 can be and/or forms a contoured surface. For example, the inner matrix surface 132 can form a surface which is contoured vertically from the top of the lower member 140 up to the bottom of the upper member 120. Additionally, the inner matrix surface 132 may be and/or forms a horizontally contoured surface, which is contoured horizontally from the lead in portion to a portion near the handle 112 (e.g., from the line L1 to the line L2).

Accordingly, in some examples, the matrix 130 can form, via the inner matrix surface 132, a contoured surface along both the horizontal and vertical dimensions and may include one or more curvatures configured to mimic a natural anatomical contour of a tooth. Additionally, the inner matrix surface 132 can be configured to abut, at least partially, one or more tooth surfaces, including subgingival tooth anatomy, during a dental procedure (e.g., with the dental procedure device disposed between two adjacent teeth).

Similarly, the matrix 130 and the inner matrix surface 132 can each be formed (e.g., shaped) to promote a natural interproximal contact between two teeth (e.g., between the teeth 10 and 12 shown in, and described in greater detail with reference to, FIG. 2). For example, a top, or uppermost, portion of the matrix 130 can be formed to promote a contact at portions of both teeth between which the matrix 130 is inserted, which are portions of the teeth not being restored via a dental procedure (e.g., the matrix 130 can be configured to provide physical contact with a tooth to be restored and also provide physical contact with an adjacent tooth). In some embodiments, the matrix 130 may provide a contact to two adjacent teeth to facilitate a dental restoration procedure (e.g., filling) in each of the teeth in physical contact with the matrix 130 (e.g., the matrix may include an outer surface, similar to the inner matrix surface 132 such that the matrix 130 forms a double-sided dental matrix to perform a dental procedure in each of two adjacent teeth).

In some examples, the matrix 130 can include a vertically straight contour (e.g., no vertical contour) proximate to the lead in portion 144 (e.g., to the left of line L2). Additionally, the matrix 130 can include a vertically contoured region in a central region of the matrix 130 (e.g., to the right of the line L2). Further, the matrix 130 can be vertically straight again proximate to the handle 112 (e.g., at the line L1). The matrix 130 and/or the inner matrix surface 132 can further include a contour to facilitate control and confinement of one or more restorative materials used during a dental procedure (e.g., one or more materials used to form a dental filling). In some embodiments, the matrix 130 can include horizontal contours, which are located in a buccal area and in a lingual area and which may support a buccal seal and a lingual seal, as described in greater detail below with reference to FIGS. 2 and 3.

In some embodiments, the matrix 130 may include a uniform cross-sectional area (e.g., thickness), such as the cross-sectional area of the matrix 130 that is shown in FIG. 1D. However, in other embodiments, the matrix 130 may include a non-uniform cross-sectional area and may instead have a varying thickness along the length and/or height of the matrix 130 (e.g., horizontally varying thickness, which may differ at any point between the end of the matrix 130 from the lead in portion 144 to the opposite end of the matrix 130 proximate to the handle 112, and/or vertically varying thickness, which may differ at any point between the upper member 120 and lower member 140). For example, the matrix 130 may, in some embodiments, include two or more different thicknesses or cross-sectional areas. Relatedly, and as described above, the matrix 130 may include one or more regions with variable degrees of vertical and/or horizontal contour (e.g., curvature). Accordingly, the matrix 130 may include a vertically straight portion, followed by a vertically curved portion, and may terminate with a vertically straight portion, which may each have individual and/or varying thicknesses.

As described above, the lower member 140 can include an inner surface 142, which can each be formed (e.g., shaped) to physically contact the tooth to be restored (e.g., the tooth 10 shown in, and described in greater detail with reference to, FIG. 2) and separate it from a portion of gingiva proximal to the tooth to be restored. For example, the lower member 140 can include a downward protruding portion 146 which extends downward in an arched shape to facilitate a separation of the gingiva and a tooth to be restored and/or to confine dental materials during a dental procedure to restore a vertically large dental cavity (e.g., to form a filling in a cavity near the base of the tooth).

For example, the downward protruding portion 146 may be formed in a convex, arched, and/or curved shape and the inner surface 142 may change in size according to the arc or curve of the downward protruding portion 146 (e.g., the area of the inner surface 142 may increase along a curved downward portion 146 from the handle 112 towards the lead in portion 144 until the peak of the curve formed by the downward protruding portion 146). Similar to the matrix 130, the inner surface 142 can form a surface which is contoured vertically and/or horizontally. For example, the inner surface 142 can include a contour (e.g., shape or profile) that varies vertically (e.g., from a bottom of the downward protruding portion 146 up to the bottom of the matrix 130). The downward protruding portion 146 may also extend forward and away from a reference pane formed by the inner matrix surface 132 (e.g., extending ‘out of the page’ or towards the viewer in the embodiment depicted in FIG. 1A). Accordingly, the lower member 140 may include a three-dimensional contour, which may include one or more contours in the inner surface 142 of the lower member.

Similarly, the inner surface 142 can include a contour that varies horizontally (e.g., from a proximal portion of the lower member 140 proximal to the handle 112 to a distal portion of the lower member 140 near the lead in portion 144). For example, the inner surface 142 of the lower member 140 can include a vertical contour that is a first curve with a first depth and a horizontal contour which is a second curve with a second depth, which is less than the first depth (or vice versa). Stated differently, the downward protruding portion 146 (e.g., at the bottom edge of the inner surface 142) can include a curved shape (e.g., a dip or downward extending arc) that is configured to support and/or enable dental restoration procedures for deep caries and may further promote a gingival seal provided by the dental procedure device 100 to prevent (or inhibit) saliva, blood or other contaminants from entering a restoration area and/or to contain one or more dental materials used during a dental procedure.

In some embodiments, the lead in portion 144 can be an extension of and/or include at least a portion of the upper member 120, the matrix 130, and/or the lower member 140. Additionally, in some embodiments, the lead in portion 144 of the lower member 140 can be configured to facilitate insertion of the dental procedure device between two adjacent teeth. More specifically, the body 110 and the lead in portion 144 specifically, can be configured to be inserted by a user between two adjacent teeth, where the direction of insertion for the device 100 follows, and/or may be determined by, the shape or curvature of at least a portion of the upper member 120, the matrix 130, and/or the lower member 140. More specifically, the device 100 may be configured for insertion between two adjacent teeth with the inner surface 142 of the lower member 140, the matrix surface 132, and/or the upper wedge portion 122 of the upper member 120 physically contacting and/or wrapping around one of the adjacent teeth (e.g., as shown in FIGS. 2 and 3). In some embodiments the lead in portion 144 may be isolated to one of the upper portion, the matrix portion, or the lower portion.

In some embodiments, the body 110 and/or handle 112 of the dental procedure device 100 can be at least partially transparent to allow for the curing of one or more restorative materials used during a dental procedure with the dental procedure device in-situ.

FIG. 1B is a bottom view of a dental procedure device 100, according to some embodiments. As described above, the dental procedure device 100 can include the body 110, a handle 112 physically connected to the body 110, the lower member 140, and the upper wedge portion 122.

The horizontal contour, or lateral shape, of the lower member 140 can be seen in FIG. 1B, which includes a portion of the inner surface 142 that is curved proximal to the handle 112 and a distal portion of the inner surface 142 (e.g., proximate to and/or forms part of the lead in portion 144) that is substantially straight and that may form an angle with respect to the body 110. The lower member 140 can include a first portion near the handle 112 that is substantially straight, a second, curved, portion with a varying horizontal contour (e.g., a ‘C’ shape) that ends in a straight line, and the lead in portion 144 angled away from the straight line at the end of the horizontal contour of the lower member 140. The lower member can include a curvature (e.g., a portion of the lower member 140 that is ‘C’ shaped when viewed from above and/or below) configured to provide and/or increase a clamping force between the lower member 140 and/or inner surface 142 and, thereby, improve and/or enable a liquid seal between the dental procedure device 100 and one or more buccal and/or lingual regions of a tooth. Stated differently, the lower member 140 can be shaped to allow it, the matrix 140, and/or the upper member 120 to physically mimic one or more natural contours of a tooth when the device 100 is inserted between two adjacent teeth and, thereby, may allow and/or increase physical contact between one or more portions of the device 100 and the tooth.

The lead in portion 144 may be formed with a substantially straight shape (e.g., with little or no horizontal contour) and/or form a substantially straight tip of the lower member 140 (e.g., as shown in FIG. 4). The angle of the lead in portion 144 can be configured to allow the lead in portion 144 to curve toward the tooth to receive the tooth during insertion of the dental procedure device 100 for a dental procedure and to reduce the interaction between the device 100 and the cheek and/or tongue during insertion of the device 100. In some examples, the lead in portion 144 can be formed at an angle with respect to the lower member 140, as shown in FIG. 1B. In some examples, the lead in portion 144 can be formed at an angle that differs from (e.g., greater or less than) the angle of the lead in portion 144 shown in FIG. 1B. Moreover, in some examples, the angle of the lead in portion 144 can be configured to facilitate the insertion of the dental procedure device 100 between two adjacent teeth. In some embodiments, the lead in portion 144 can include notched or keyed features to facilitate the insertion of more than one dental procedure device.

FIG. 1C is a top view of a dental procedure device 100, according to some embodiments. As described above, the dental procedure device 100 shown in FIG. 1C can include the body 110, the handle 112, the upper member 120, the upper wedge portion 122, the lower member 140, and the lead in portion 144. FIG. 1C illustrates a horizontal contour of the lower member 140 and of the upper member 120, which is curved in a region proximal to the handle 112 and that is substantially straight at a distal region of the lower member 140, which is proximate to, and/or forms part of, the lead in portion 144.

Additionally, the upper member 120 can include a portion, as can be seen in FIG. 1C, that is substantially straight, which is located at a distal region of the upper member 120 proximate to, and/or forms part of, the upper wedge portion 122. Stated differently, the upper member 120 can include a first straight (or substantially straight) portion near the handle 112, a curved portion with a varying horizontal contour, and a second straight portion proximate to a tip of the upper wedge member 122 and/or the lead in portion 144.

As can be seen in FIG. 1C, the lead in portion 144 can be formed at an angle with respect to the second straight portion of the upper member 120. More specifically, the lead in portion 144 may include a substantially angled tip and/or form a substantially angled tip of the lower member 140. As described above, in some examples, the lead in portion 144 can be formed at an angle with respect to the straight portion of the lower member 140, as shown in FIG. 1B.

As described above for the lower member 140, the upper member 120 can similarly include a first portion near the handle 112 that is substantially straight, a second, curved, portion with a varying horizontal contour (e.g., curved and/or contoured shape), and a third portion that is proximate to the lead in portion 144 and that is substantially straight. The upper member can be contoured and/or shaped (e.g., include one or more portions of the lower member 140 that form a ‘C’ shape, when viewed from above and/or below) to provide and/or increase a clamping force between the lower member 140 and/or inner surface 142 when the device 100 is inserted between two adjacent teeth. As a result, the upper member 120 may, in some examples, improve and/or enable a liquid seal between the dental procedure device 100 and one or more regions of a tooth. Stated differently, the curved shape of the upper member 120 can allow it, the matrix 130, and/or the lower member 140 to physically mimic one or more natural contours of a tooth to enable and/or facilitate physical contact between one or more portions of the device 100 and one or more portions of a tooth. For example, the upper member may be shaped to improve and/or enable a seal between the device 100 and a buccal and/or lingual portions of the tooth.

Stated differently, in some examples, the upper member 120 may include a three-dimensional contour (e.g., shape) that mimics one or more natural contours of a marginal ridge up to, including and beyond line angles of a tooth. Accordingly, the upper member 120 may include a three-dimensional contour to confine and shape restoration material during a dental procedure to provide, in a resulting dental restoration (e.g., shape a dental filling), a corresponding contour that likewise mimics the natural contour of the marginal ridge of the restored tooth.

FIG. 1D is a cross section view of a dental procedure device 100, according to some embodiments. FIG. 1D depicts a cross-sectional view of the dental procedure device 100 at a center between line L1 and line L2 shown in FIG. 1A. As described above, the dental procedure device 100 can include the body 110, the upper member 120, the matrix 130, and the lower member 140. The upper member 120 can include the upper protrusion 124 and the upper surface 126.

In some examples, the upper member 120 can be formed with a cross-sectional area configured to support one or more natural contours of a marginal ridge of a tooth during a dental procedure. Additionally, the upper member 120 can include an upper surface 126. The upper member 120 can be configured, with the matrix 130 and the lower member 140, to facilitate and/or enable the separation of two adjacent teeth (e.g., the adjacent teeth 10 and 12 shown in FIG. 2) by the dental procedure device 100. For example, the upper protrusion 124 can be shaped and sized (e.g., extending vertically upward and backward, at an angle, with respect to the inner matrix surface 132) to physically separate two adjacent teeth when the dental procedure device 100 is inserted between them (e.g., with the device 100 inserted as shown in FIGS. 2 and 3).

The upper member 120 may further facilitate and/or enable the device 100 to separate the two adjacent teeth by physically supporting the lower member 140, which may wedge or physically abut, one or more of the two adjacent teeth and thereby cause the lower member 140 to remain engaged on, or in contact with, one or more of the teeth via a tension with the upper member 120 and provided via the matrix 130. More specifically, the body 110 and each of the upper member 120, the matrix 130, and the lower member 140 may be formed from one or more rigid and/or malleable materials. Accordingly, with the upper member 120 abutting one or more of the two adjacent teeth, and physically connected to the lower member 140 via a matrix 130 (e.g., formed from a structural, rigid, semi-rigid, and/or malleable material), a tension can exist, via the matrix 130, between the upper member 120 and the lower member 140 as a result of their respective positions between the two adjacent teeth.

In some embodiments, the matrix 130 may include a uniform cross-sectional area (e.g., a constant thickness), as shown in FIG. 1D. However, in other embodiments, the matrix 130 may include a non-uniform cross-sectional area, which is a cross-sectional area that may vary at one or more portions of the matrix 130 (e.g., the matrix 130 may have a varying thickness along the length and/or height of the body 110). Stated differently, the matrix 130 may, in some examples, include a horizontally and/or vertically varying thickness, which can differ at any point along the length and/or height of the matrix 130 (e.g., the matrix 130 may, in some examples, include two or more portions each with different thicknesses or cross-sectional areas).

The lower member 140 can include the inner surface 142, the downward protruding portion 146, an outer element 160 (e.g., formed in an outer surface of the dental procedure device), a crush rib 162, and a curved lower surface 164. The downward protruding portion 146 can form part of a vertical contour of the inner surface 142 of the lower member 140. The lower member 140 can be configured to control and confine restorative materials during a dental procedure (e.g., one or more resins and/or adhesives used during a dental restoration).

For example, the downward protruding portion 146 may be formed in an arc or curved shape and the inner surface 142 may change in size along one or more portions of the arc or curve of the downward protruding portion 146 (e.g., the area of the inner surface 142 may increase along a downward protruding portion 146 from a region proximate to the handle 112 to the greatest point in a curve formed by the downward protruding portion 146). In some embodiments, the inner surface 142 can include a curved lower surface (e.g., proximal to, and/or formed by, the downward protruding portion 146), which can be configured, with the downward protruding portion 146, to slide into a gingival sulcus of a tooth (e.g., between gingiva and the tooth 10 shown in FIG. 2) to separate a portion of gingiva from the tooth (e.g., the tooth 10 shown in FIG. 2) during a dental procedure and thereby prevent and/or reduce injury to that portion of gingiva during the dental procedure. The inner surface 142 and/or the downward protruding portion 146 can be configured to allow for restoration of deep caries, and prevent and/or reduce an amount of unwanted restoration material (e.g., restoration overhang) from being present outside an area or volume intended for a dental procedure (e.g., outside of a cavity in a tooth into which one or more dental restoration materials are deposited) by providing a physical space with a substantially uniform transition between the restorative material retained by the dental procedure device 100 and the tooth receiving the dental procedure (e.g., providing a substantially smooth and/or uniform physical transition between restoration material and the tooth structure).

As described above, the inner surface 142 can form a surface which is contoured vertically and horizontally. For example, the inner surface 142 can include a contour (e.g., shape or profile) that varies vertically (e.g., from a bottom of the downward protruding portion 146 up to the bottom of the matrix 130). The downward protruding portion 146 may also extend forward and away from a reference pane formed by the inner matrix surface 132 (e.g., extending ‘out of the page’ or towards the viewer in the embodiment depicted in FIG. 1A). Accordingly, the lower member 140 may include a three-dimensional contour, which may include one or more contours in the inner surface 142 of the lower member.

Relatedly, the cross-sectional area of the lower member 140 can change in size along the length of the body 110 (e.g., increase and/or decrease in thickness along the length of the body from the lead in portion 144 toward the handle 112). For example, the cross-sectional area of the lower member 140 can gradually increase and/or decrease in size along one or more portions of the lower member 140 (e.g., increase in thickness while transversing a portion of the lower member 140 from the lead in portion 144 to the handle 112). To give another, more specific, example, the cross-sectional area of the lower member 140 may increase in one portion, decrease in another portion, then increase again in another distal portion of the lower member 142 (e.g., a thickness that increases near the handle 112, decreases in a mid-portion of the lower member 140, and increase again towards the tip of the lower member 140 and/or near the lead in portion 144).

Stated differently, in some examples, the lower member 140 can include one or more portions that have a thickness that is greater than a thickness of the matrix 130 proximate to that portion of the lower member 130 (e.g., at that same portion of the dental procedure device 100). For example, the lower member 140 may include two regions that are significantly thicker than the matrix 130 (e.g., two or more regions with a cross-sectional area that is two or more times greater than the cross-sectional area of the matrix 130), which may be separated by a third region of the lower member 130 with a thickness that is greater than that of the matrix 130 but less than that of the two regions that are significantly thicker than the matrix 130 (e.g., 1.1 to 1.9 times the thickness, or cross-sectional area, of the matrix 130). Accordingly, in some examples, one or more portions of the lower member 130 may each include a cross-sectional area that is less than, equal to, or greater than, the cross-sectional area of the matrix 130.

In some examples, the shape of the lower member 140 can be configured to separate, or to aid in separating, two adjacent teeth to facilitate appropriate contact between the teeth after the completion of a dental procedure (e.g., after formation of a dental filling). However, in other embodiments, the lower member 140 may include one or more portions with different cross-sectional shapes and it need not be limited to a triangular and/or V-shaped cross section. Accordingly, the lower member 140 can include any suitable cross-sectional shape, including, for example, a triangular shape, a rectangular shape, a V-shape, a U-shape, a Y-shape, a W-shape a circular and/or semi-circular shape, and/or a polygonal shape. In addition, it may be rail shaped, split designed, fan shaped, wafer designed, honeycombed, wavy, beaded, chained, segmented, interrupted, hollow, solid, or filled. The shape may change direction, size and may utilize several shapes. The shape of the lower member 140 may have retentive features such as bumps, rough teeth like protuberances, or various materials, adhesives, or expanding, absorbent, or inflatable materials to gain retention and/or separate the teeth.

In some embodiments, the crush rib 162 can be configured to increase and/or enable a wedging force between the lower member 140 and at least one of the two adjacent teeth, which can, as a result, enable and/or increase a gingival seal between the lower member 140 and a tooth to receive the dental procedure (e.g., a tooth in which a dental filling may be formed). The gingival seal, or increase thereto, provided by the crush rib 162 can contain and/or shape restoration materials during a dental procedure and may further prevent saliva or other liquids from flowing between the lower member 140 and the tooth in which a dental restoration is performed (e.g., to prevent liquid from contacting the inner surface 142, the tooth, and/or a restoration material used during a dental procedure).

In some embodiments, the gingiva-contacting surface 164 can be configured to eliminate or reduce injury to the gingiva during insertion and removal of the dental restoration device, and/or during the dental procedure. For example, the gingiva-contacting surface may have a concave curvature which aides in separating the gingiva from the tooth while allowing the dental procedure device to slide overtop the gingiva without, or with minimal, pinching, cutting or abrading of the gingival tissue. However, in other embodiments, the gingiva-contacting surface 164 may include one or more portions with different cross-sectional shapes and it need not be limited to a concave cross section. Accordingly, the gingiva-contacting surface 164 can include any suitable cross-sectional shape, including, for example, a linear, a convex, a V-shape, a U-shape, a Y-shape, a W-shape, a circular and/or semi-circular shape, and/or a polygonal shape. In addition, it may be rail shaped, split designed, fan shaped, wafer designed, honeycombed, wavy, beaded, chained, segmented, interrupted, hollow, solid, or filled partly or fully with a dissimilar material. The shape may change direction, size and may utilize several shapes.

FIG. 1E is a perspective view of a dental procedure device 100, according to some embodiments. The dental procedure device 100 can include a body 110 and a handle 112 physically connected to the body 110. In some examples of the present disclosure, the body 110 and the handle 112 can be formed from the same material (e.g., a single continuous material), such as a polymer. Additionally, in some embodiments, the body 110 can form a single continuous surface (e.g., via the inner surface 142, the matrix surface 132, upper wedge portion 122, and/or any portions thereof). Additionally, in some examples, the body 110, or one or more portions thereof, and the handle 112 may be formed from one or more different materials (e.g., different polymers, metals, etc.).

In some embodiments, the dental procedure device 100 can include a lead in portion 144 with one or more shaped tips, including, for example, a U-shaped tip, an inverted V-shaped tip, a V-shaped tip, a W-shaped tip, and/or any other suitable shaped tips. Additionally, as described above, the lead in portion 144 may be formed by one or more portions of the body 110, including the upper member 120, the matrix 130, and/or the lower member 140. Similarly, as also described herein, the lead in portion may extend away from the body 110 with an angle different from the one shown in FIG. 1E, including, for example, curving away from the body 110 in a direction opposite the curvature of the matrix 130.

The body 110 of the dental procedure device 100 can include an upper member 120, a matrix 130, and a lower member 140. As mentioned previously, the different portions of the body 110 can all be formed from a single material, such as a single continuous polymer. However, in some examples, the body 110 can include one or more components formed of one or more different materials. For example, the upper and/or lower members 120, 140 of the body 110 may each be formed from a polymer material that physically encompasses a metal material which can form at least a portion of the matrix 130 and/or other portions of the body 110 (e.g., as described in greater detail below, with reference to FIGS. 5-7.)

In some examples, the upper member 120 can be formed with a cross-sectional area configured to support one or more natural contours in a marginal ridge of a tooth during a dental procedure. Additionally, the upper member 120 can include an upper wedge portion 122 and an upper surface 126. The upper wedge portion 122 can be formed to angle away from the upper surface 126 of the upper member 120 (e.g., as described in greater detail above, with reference to FIG. 1E). In some embodiments, the upper wedge portion 122 may be shaped to provide support and structure (e.g., an amount of physical rigidity without an undesirable reduction in flexibility) to the matrix 130, including during and after insertion of the dental procedure device 130 and during a dental procedure (e.g., a dental restoration or filling).

In some embodiments, at least a portion of the upper member and/or the upper protrusion 124 can extend away from the tooth and/or inner matrix surface 132 with a curved and/or contoured shape (e.g., a ‘dog-ear’ shape or outward curve), referred to herein as a curved extension 150. The curved extension 150 may be, and/or include, one or more portions of the upper member 120 and/or matrix 130, that curves away from the tooth to receive the dental procedure device and/or inner matrix surface 132 and may be configured to facilitate the insertion of the dental procedure device 100 between two adjacent teeth (e.g., as shown in FIGS. 2 and 3). The curved extension 150 can be configured to facilitate and/or allow the device 100 to traverse a proximal box of a tooth during insertion of the device 100. In some embodiments, the curved extension 150 can include a portion of the upper member 120, upper wedge 122, upper protrusion 124 and/or the matrix 130 that is disposed to the left of the line L2. In another example, the curved extension 150 can include and/or be formed by the portion of the upper member 120, upper wedge 122, upper protrusion 124 and/or the matrix 130 disposed to the left of a region located between the lines L2 and L1. In still other examples, the curved extension 150 can include the portion of the upper member 120, upper wedge 122, upper protrusion 124 and/or the matrix 130 that is disposed to the left of the line L1.

In some embodiments, the cross-sectional area of the lower member 140 can gradually increase in size from the lead in portion 144 to the line L2. The change in the thickness, or the increase in the cross-sectional area, of the lower member 140 can be configured to facilitate physical insertion of the lead in portion 144 and the rest of the dental procedure device 100 between two adjacent teeth (e.g., facilitate insertion of the device 100 as shown in FIGS. 2 and 3). In some examples, a thickness of the lower member 140 (e.g., a size of the cross-sectional area of the lower member 140 between the tip of the lead in portion 144 and the line L2) can be configured to facilitate insertion in a variety of different physical, anatomical and/or procedural circumstances (e.g., in dental procedures involving a variety of different dental anatomies).

FIG. 2 is a top view of a dental procedure device 200 inserted between two adjacent teeth 10 and 12, according to some embodiments. As described above, the dental procedure device 200 can be configured to confine and shape restorative materials within a dental cavity 11 and on one or more tooth surfaces requiring restoration including, but not limited to, a proximal surface, or subgingival anatomy during a dental procedure as shown in FIG. 2 and FIG. 3.

The dental procedure device 200 can include a body 210 and a handle 212 physically connected to the body 210. The body 210 of the dental procedure device 200 can include an upper member 220, a matrix (not shown in FIG. 2, see, for example, the matrix 130 shown in FIGS. 1A-1E), and a lower member 240. Additionally, the upper member 220 can include an upper wedge portion 222, an upper protrusion 224, and an upper surface 226. The upper wedge portion 222 can be formed to angle away from the upper surface 226 of the upper member 220 (e.g., as described in greater detail above, with reference to FIG. 1D). The matrix can include an inner matrix surface. Additionally, the lower member 240 can include an inner surface (not shown in FIG. 2, see, for example, the inner surface 142 shown in FIGS. 1A-IE), a lead in portion 244 (also referred to herein as an insertion tip 244 and/or an insertion member 244), and a downward protruding edge (not shown in FIG. 2, see, for example, the downward protruding edge 146 shown in FIG. 1A).

As described above with reference to FIG. 1A, in some examples, the body 210 and the handle 212 can be formed from the same material (e.g., a single continuous material), such as a polymer. However, in other examples, the body 210 and/or one or more portions thereof and the handle 212 may be formed from one or more different materials (e.g., one or more different polymers, one or more metals, etc.).

In some embodiments, the handle 212 can include a handle formed with a different shape, size, and/or orientation from the handle 212 shown in FIG. 2. For example, the handle 212 can extend away from the body 210 of the dental procedure device 200 at a variety of different angles, or at no angle at all (e.g., formed physically in-line with the body 210). Additionally, in some examples, the handle 212 can extend from the body 210 at an angle based on the contours of the upper member 220, the matrix 230, and the lower member 240. For example, the handle 212 may extend away from the body 210 at a first angle for a dental procedure device to be inserted from a lingual side of a tooth and toward a buccal side of the teeth 10 and 12, which may curve in a posterior direction during insertion of the device 200 (e.g., towards the back of a mouth), as shown in FIG. 2.

Alternatively, in some examples, the handle 212 may extend away at a second angle (e.g., an angle opposite the first angle) for a dental procedure device configured for insertion in the opposite direction, that is from a buccal side of a tooth to a lingual side or in an anterior direction instead of a posterior direction with the dental procedure device 200 configured for restoration of a distal portion of the tooth 10. Additionally, in some embodiments, the dental procedure device 200 can be configured to be inserted from a buccal side of a tooth to a lingual side of a tooth to restore a mesial portion of the tooth (e.g., as shown in FIG. 3). However, the handle 212 can extend away from the body 210 with any orientation, size, or shape and is not limited to the specific example shown in FIG. 2.

The lead in portion 244 of the lower member 240 can be configured to facilitate insertion of the dental procedure device between two adjacent teeth. For example, the size, the cross-sectional area of one or more portions, and/or the angle (e.g., with respect to the lower member 240 and/or the matrix 230) of the lead in portion 244 can be configured to facilitate insertion between the two adjacent teeth 10 and 12 as shown in FIG. 2.

The body 210 and the lead in portion 244 specifically, can be configured to be inserted by a user between two adjacent teeth, whether the direction of insertion for the device 200 follows the shape and curvature of the lower member 240. More specifically, the device 200 may be configured for insertion between two adjacent teeth with the inner surface 242 of the lower member 240 physically contacting and/or wrapping around the tooth 10. For example, the device 200 can be configured with a shape and/or curvature (e.g., a shape and/or curvature of the body 210 and/or its individual component pieces) to insert the device between the teeth 10 and 12, and with the lead in portion 244 pointing to the left, from right to left with reference to the view of the teeth 10, 12 shown in FIG. 2.

FIG. 3 is a top view of a dental procedure device 300 inserted between two adjacent teeth 14 and 15, according to some embodiments. As described above, the dental procedure device 300 can be configured to confine and shape restorative materials within a dental cavity 13 and on one or more tooth surfaces requiring restoration including, but not limited to, a mesial portion of the tooth 14, a proximal surface, or subgingival anatomy during a dental procedure as shown in FIGS. 2 and 3. The dental procedure device 300 can include a body 310 and a handle 312 physically connected to the body 310. The body 310 of the dental procedure device 300 can include an upper member 320, a matrix (not shown in FIG. 3; see, for example, the matrix 130 shown in FIGS. 1A-1E), and a lower member 340. Additionally, the upper member 320 can include an upper wedge portion 322, an upper protrusion 324, and an upper surface (not shown in FIG. 3, but described in greater detail above, with reference to FIG. 1E). The upper wedge portion 322 can be formed to angle away from the upper surface of the upper member 320. The matrix can include an inner matrix surface (not shown in FIG. 3, see, for example, the inner matrix surface 132 shown in FIG. 1E). Additionally, the lower member 340 can include an inner surface (not shown in FIG. 3, see, for example, the inner surface 142 shown in FIGS. 1A-IE), a lead in portion 344 (also referred to herein as an insertion tip 344 and/or an insertion member 344), and a downward protruding edge (not shown in FIG. 3, see, for example, the downward protruding edge 146 shown in FIG. 1A).

As described above, the body 310 and the handle 312 can be formed from the same material (e.g., a single continuous material), such as a polymer. However, in other examples, the body 310 and/or one or more portions thereof and the handle 312 may be formed from one or more different materials (e.g., one or more different polymers, one or more metals, etc.). In some embodiments, the handle 312 can include a handle formed with a different shape, size, and/or orientation from the handle 312 shown in FIG. 3.

For example, the handle 312 can extend away from the body 310 of the dental procedure device 300 at a variety of different angles, or at no angle at all (e.g., formed physically in-line with the body 310). Additionally, in some examples, the handle 312 can extend from the body 310 at an angle based on the contours of the upper member 320, the matrix 330, and the lower member 340. For example, the handle 312 can extend away from the body 310 at a first angle for a dental procedure device to be inserted from a lingual side of a tooth and toward a buccal side of the teeth 14 and 15, which may curve in an anterior direction (e.g., towards the front of a mouth), as shown in FIG. 3. Alternatively, in some examples, the handle 312 may extend away at a second angle (e.g., an angle opposite the first angle) for a dental procedure device configured for insertion in the opposite direction, that is from a buccal side of a tooth to a lingual side or to be inserted in a posterior direction instead of an anterior direction (e.g., as shown in, and described with reference to, FIG. 2). However, the handle 312 can extend away from the body 310 with any orientation, size, or shape and need not be limited to the specific example shown in FIG. 3.

The lead in portion 344 of the lower member 340 can be configured to facilitate insertion of the dental procedure device between two adjacent teeth. For example, the size, the cross-sectional area of one or more portions, and/or the angle (e.g., with respect to the lower member 140 and/or the matrix 130) of the lead in portion 344 can be configured to facilitate insertion between the two adjacent teeth 14 and 15 as shown in FIG. 3.

The body 310 and the lead in portion 344 specifically, can be configured to be inserted by a user between two adjacent teeth, where the direction of insertion for the device 300 follows the shape and curvature of the lower member 340. More specifically, the device 300 may be configured for insertion between two adjacent teeth with the inner surface 342 of the lower member 340 physically contacting and/or wrapping around the tooth 14. For example, the device 300 can be configured with a shape and/or curvature (e.g., a shape and/or curvature of the body 310 and/or its individual component pieces) to insert the device between the teeth 14 and 15, and with the lead in portion 344 pointing to the left, from right to left with reference to the view of the teeth 14, 15 shown in FIG. 3.

FIG. 4 is a bottom view of a dental procedure device 400 with a straight lead in portion 444, according to some embodiments. The dental procedure device 400 can include a body 410 and a handle 412 physically connected to the body 410. The body 410 of the dental procedure device 400 can include an upper member (not shown in FIG. 4, see, for example, the upper member 120 shown in FIG. 1A), a matrix (not shown in FIG. 4, see, for example, the matrix 130 shown in FIG. 1A), and a lower member 440.

As described above, the upper member (not shown in FIG. 4, see, for example, the upper member 120 shown in FIG. 1A) can include an upper wedge portion 422, an upper protrusion (not shown in FIG. 4, see, for example, the upper member 124 shown in FIGS. 1D-1E), and an upper surface (not shown in FIG. 4, see, for example, the upper member 126 shown in FIG. 1A). The upper wedge portion 422 can be formed to angle away from the upper surface 426 of the upper member 420 (e.g., as described in greater detail above, with reference to FIG. 1D). The matrix can include an inner matrix surface.

Accordingly, the shape of the upper member (not shown in FIG. 4, see, for example, the upper member 120 shown in FIGS. 1A-1E) can be configured to separate, or to aid in separating, two adjacent teeth to facilitate appropriate contact between the teeth after the completion of a dental procedure (e.g., after formation of a dental filling). However, in other embodiments, the upper member may include a substantially straight portion in the horizontal, longitudinal, and and/or vertical directions.

The lower member 440 can include an inner surface (not shown in FIG. 4, see, for example, the inner surface 142 shown in FIGS. 1A-IE), a lead in portion 444 (also referred to herein as an insertion tip 444 and/or an insertion member 444), and a downward protruding edge (not shown in FIG. 4, see, for example, the downward protruding edge 146 shown in FIG. 1A).

As described above, the lead in portion 444 of the lower member 440 can be configured to facilitate insertion of the dental procedure device between two adjacent teeth. More specifically, the body 410 and the lead in portion 444 can be configured to be inserted by a user between two adjacent teeth where the direction of insertion for the device 400 follows the shape and curvature of the lower member 440. More specifically, the device 400 may be configured for insertion between two adjacent teeth with the inner surface 442 of the lower member 440 physically contacting and/or wrapping around one of the adjacent teeth (e.g., as shown in FIGS. 2 and 3).

In some examples, the lead in portion 444 may be formed in a substantially straight shape (e.g., with little or no horizontal contour when viewed vertically, as shown in FIG. 4) and/or form a substantially straight tip of the lower member 440 (e.g., as shown in FIG. 4). In other embodiments, however, the lead in portion 444 can be formed at an angle, as described above (e.g., as shown in FIGS. 2 and 3). In those embodiments, the angle of the lead in portion 444 can be configured to allow the lead in portion 444 to curve toward the tooth to receive a dental procedure and to reduce the interaction between the device 400 and the cheek and/or tongue during insertion of the device 400.

The cross-sectional area of the lower member 440 can change in size along the length of the body 410 (e.g., increase and/or decrease in thickness along the length of the body from the lead in portion 444 toward the handle 412). For example, the cross-sectional area of the lower member 440 can gradually increase and/or decrease in size along one or more portions of the lower member 440 (e.g., increase in thickness while transversing a portion of the lower member 440 from the lead in portion 444 to the handle 412). To give another, more specific, example, the cross-sectional area of the lower member 440 may increase in one portion, decrease in another portion, then increase again in another, distal, portion of the lower member 442 (e.g., a thickness that increases near the handle 412, decreases in a mid-portion of the lower member 440, and increase again towards the tip of the lower member 440 and/or near the lead in portion 444).

Accordingly, the shape of the lower member 440 can be configured to separate, or to aid in separating, two adjacent teeth to facilitate appropriate contact between the teeth after the completion of a dental procedure (e.g., after formation of a dental filling). However, in other embodiments, the lower member 440 may include one or more portions with different cross-sectional shapes and it need not be limited to a V-shaped cross section. Accordingly, the lower member 440 can include any suitable cross-sectional shape, including, for example, a triangular shape, a rectangular shape, a V-shape, a U-shape, a Y-shape, a W-shape a circular and/or semi-circular shape, and/or a polygonal shape. In addition, it may be rail shaped, split designed, fan shaped, wafer designed, honeycombed, wavy, beaded, chained, segmented, interrupted, hollow, solid, or filled. The shape may change direction, size and may utilize several shapes.

Accordingly, the shape of the lower member 440 can be configured to separate, or to aid in separating, two adjacent teeth to facilitate appropriate contact between the teeth after the completion of a dental procedure (e.g., after formation of a dental filling). However, in other embodiments, the lower member 440 may include a substantially straight portion in the horizontal, longitudinal, and and/or vertical directions.

FIG. 5 is a front view of a dental procedure device 500, according to some embodiments. The dental procedure device 500 can include a body 510 and a handle 512 physically connected to the body 510. The body 510 of the dental procedure device 500 can include an upper member 520, a matrix 530, and a lower member 540. Additionally, the upper member 520 can include an upper wedge portion 522, an upper protrusion 524, and an upper surface 526. The upper wedge portion 522 can be formed to angle away from the upper surface 526 of the upper member 520 (e.g., as described in greater detail above, with reference to FIG. 1D). The matrix can include an inner matrix surface. Additionally, the lower member 540 can include an inner surface 542, a lead in portion 544 (also referred to herein as an insertion tip 544 and/or an insertion member 544), and a downward protruding edge 546.

In some embodiments, at least a portion of the upper member and/or the upper protrusion 524 can extend away from the tooth and/or inner matrix surface 532 with a curved and/or contoured shape (e.g., a ‘dog-ear’ shape or outward curve), referred to herein as a curved extension 550. The curved extension 550 may be, and/or include, one or more portions of the upper member 520 and/or matrix 530, that curves away from the tooth to receive the dental procedure device and/or inner matrix surface 532 and may be configured to facilitate the insertion of the dental procedure device 500 between two adjacent teeth (e.g., as shown in FIGS. 2 and 3). The curved extension 550 can be configured to facilitate and/or allow the device 500 to traverse a proximal box of a tooth during insertion of the device 500. In some embodiments, the curved extension 550 can include a portion of the upper member 520, upper wedge 522, upper protrusion 524 and/or the matrix 530 that is disposed to the left of the line L2. In another example, the curved extension 550 can include and/or be formed by the portion of the upper member 520, upper wedge 522, upper protrusion 524 and/or the matrix 530 disposed to the left of a region located between the lines L2 and L1. In still other examples, the curved extension 550 can include the portion of the upper member 520, upper wedge 522, upper protrusion 524 and/or the matrix 530 that is disposed to the left of the line L1.

In the embodiment of the dental procedure device 500 shown in FIG. 5, the matrix 530 can be at least partially formed from a dissimilar material such as a metal, ceramic, fabric, mesh composite or other polymer including films, dissolvable, and or retained materials and with the rest of the body 510 of the dental procedure device 500 (e.g., the upper member 520, the lower member 540, etc.) formed from a polymer or non-metallic material (e.g., as described above with reference to FIGS. 1A-4). For example, the matrix 530 can include a metallic element 534, which forms a central portion of the matrix 530 and, as a result, the matrix inner surface 532. While the dissimilar material is not limited to a metallic element or an element formed from a metal, it will be referred to herein as a metallic element.

In some embodiments, the metallic element 534 can include a rigid, semi-rigid, piece of metal that is formed and/or shaped according to the inner matrix surface 532 as described in greater detail above (e.g., with a vertical and/or horizontal contour in the inner matrix surface 532 and/or the metallic element 534). The body 510 can include the metallic element 534 that is formed from a stamped piece of metallic material (e.g., steel and/or any other metal or metal alloy), with the upper member 520 and/or the lower member 540 formed from a polymer that is heat staked, over molded, or otherwise formed around or adhered to the stamped piece of metallic material. For example, the portions of the body 510 formed from a polymer material (e.g., the upper and/or lower members 520, 540) may encompass, or be physically formed around, each side, or edge, of the metallic element 534 (e.g., as shown in FIG. 5).

The metallic element 534 may increase the overall rigidity, flexibility, malleability, elasticity, and/or hardness of the body 510 and may prevent, and/or substantially reduce, unwanted deformation of the matrix 530, the inner matrix surface 532, and/or any other portion of the body 510 after insertion of the dental procedure device 500 between two adjacent teeth. Additionally, in some embodiments, the metallic element 534 may increase stiffness of the dental procedure device 500 for insertion but can also be configured to allow a user to deform or shape the metallic element 534 (e.g., burnish) to promote a tighter contact between the adjacent teeth between which the dental procedure device 500 may be inserted.

FIG. 6 is a front view of a dental procedure device 600, according to some embodiments. The dental procedure device 600 can include a body 610 and a handle 612 physically connected to the body 610. The body 610 of the dental procedure device 600 can include an upper member 620, a matrix 630, and a lower member 640. Additionally, the upper member 620 can include an upper wedge portion 622, an upper protrusion 624, and an upper surface 626. The upper wedge portion 622 can be formed to angle away from the upper surface 626 of the upper member 620 (e.g., as described in greater detail above, with reference to FIG. 1D). The matrix can include an inner matrix surface. Additionally, the lower member 640 can include an inner surface 642, a lead in portion 644 (also referred to herein as an insertion tip 644 and/or an insertion member 644), and a downward protruding edge 646.

In some embodiments, at least a portion of the upper member and/or the upper protrusion 624 can extend away from the tooth and/or inner matrix surface 632 with a curved and/or contoured shape (e.g., a ‘dog-ear’ shape or outward curve), referred to herein as a curved extension 650. The curved extension 650 may be, and/or include, one or more portions of the upper member 620 and/or matrix 630, that curves away from the tooth to receive the dental procedure device and/or inner matrix surface 632 and may be configured to facilitate the insertion of the dental procedure device 600 between two adjacent teeth (e.g., as shown in FIGS. 2 and 3). The curved extension 650 can be configured to facilitate and/or allow the device 600 to traverse a proximal box of a tooth during insertion of the device 600. In some embodiments, the curved extension 650 can include a portion of the upper member 620, upper wedge 622, upper protrusion 624 and/or the matrix 630 that is disposed to the left of the line L2. In another example, the curved extension 650 can include and/or be formed by the portion of the upper member 620, upper wedge 622, upper protrusion 624 and/or the matrix 630 disposed to the left of a region located between the lines L2 and L1. In still other examples, the curved extension 650 can include the portion of the upper member 620, upper wedge 622, upper protrusion 624 and/or the matrix 630 that is disposed to the left of the line L1.

In the embodiment of the dental procedure device 600 shown in FIG. 6, the matrix 630 can be at least partially formed from a dissimilar material such as a metal, ceramic, fabric, mesh composite or other polymer material, including, for example, films, dissolvable materials and/or retained materials and with the rest of the body 610 of the dental procedure device 600 (e.g., the upper member 620, the lower member 640, etc.) can be formed from a polymer or non-metallic material (e.g., as described above with reference to FIGS. 1A-4). For example, the matrix 630 can include a metallic element 634, which forms a central portion of the matrix 630 and, as a result, the matrix inner surface 632. However, as can be seen in FIG. 6, the metallic element 634 can be formed with any suitable size (e.g., larger than the metallic element 534 shown in FIG. 5), including a size that forms all, or substantially all, of the matrix 630 and the inner matrix surface 632. While the dissimilar material is not limited to a metallic element or an element formed from a metal material, it will be referred to herein as a metallic element.

In some embodiments, the metallic element 634 can include a rigid, or semi-rigid, piece of metal that is formed and/or shaped according to the inner matrix surface 632 as described in greater detail above (e.g., with a vertical and/or horizontal contour in the inner matrix surface 632 and/or the metallic element 634). The body 610 can include the metallic element 634 that is formed from a stamped piece of metallic material (e.g., steel and/or any other metal or metal alloy), with the upper member 620 and/or the lower member 640 formed from a polymer that is heat staked, over molded, or otherwise formed around or adhered to the stamped piece of metallic material. For example, the portions of the body 610 formed from a polymer material (e.g., the upper and/or lower members 620, 640) may encompass, or be physically formed around, each side, or edge, of the metallic element 634 (e.g., as shown in FIG. 6).

As described above, the metallic element 634 may increase the overall rigidity, flexibility, malleability, elasticity, and/or hardness of the body 610 and may prevent, and/or substantially reduce, unwanted deformation of the matrix 630, the inner matrix surface 632, and/or any other portion of the body 610 after insertion of the dental procedure device 600 between two adjacent teeth. Additionally, in some embodiments, the metallic element 634 may increase stiffness of the dental procedure device 600 for insertion but can also be configured to allow a user to deform or shape the metallic element 634 (e.g., burnish) to promote a tighter contact between the adjacent teeth between which the dental procedure device 600 may be inserted.

FIG. 7 is a front view of a dental procedure device 700, according to some embodiments. The dental procedure device 700 can include a body 710 and a handle 712 physically connected to the body 710. The body 710 of the dental procedure device 700 can include an upper member 720, a matrix 730, and a lower member 740. Additionally, the upper member 720 can include an upper wedge portion 722, an upper protrusion 724, and an upper surface 726. The upper wedge portion 722 can be formed to angle away from the upper surface 726 of the upper member 720 (e.g., as described in greater detail above, with reference to FIG. 1D). The matrix can include an inner matrix surface. Additionally, the lower member 740 can include an inner surface 742, a lead in portion 744 (also referred to herein as an insertion tip 744 and/or an insertion member 744), and a downward protruding edge 746.

In some embodiments, at least a portion of the upper member and/or the upper protrusion 724 can extend away from the tooth and/or inner matrix surface 732 with a curved and/or contoured shape (e.g., a ‘dog-ear’ shape or outward curve), referred to herein as a curved extension 750. The curved extension 750 may be, and/or include, one or more portions of the upper member 720 and/or matrix 730, that curves away from the tooth to receive the dental procedure device and/or inner matrix surface 732 and may be configured to facilitate the insertion of the dental procedure device 700 between two adjacent teeth (e.g., as shown in FIGS. 2 and 3). The curved extension 750 can be configured to facilitate and/or allow the device 700 to traverse a proximal box of a tooth during insertion of the device 700. In some embodiments, the curved extension 750 can include a portion of the upper member 720, upper wedge 722, upper protrusion 724 and/or the matrix 730 that is disposed to the left of the line L2. In another example, the curved extension 750 can include and/or be formed by the portion of the upper member 720, upper wedge 722, upper protrusion 724 and/or the matrix 730 disposed to the left of a region located between the lines L2 and L1. In still other examples, the curved extension 750 can include the portion of the upper member 720, upper wedge 722, upper protrusion 724 and/or the matrix 730 that is disposed to the left of the line L1.

In the embodiment of the dental procedure device 700 shown in FIG. 7, the matrix 730 can be all or substantially all formed from a dissimilar material such as a metal, ceramic, fabric, mesh composite or other polymer including films, dissolvable and/or retained materials and with the rest of the body 710 of the dental procedure device 700 (e.g., the upper member 720, the lower member 740, etc.) can be formed from a polymer or other non-metallic material (e.g., as described above with reference to FIGS. 1A-4). For example, the matrix 730 can include a metallic element 734, which forms a central portion of the matrix 730 and, as a result, the matrix inner surface 732. However, as can be seen in FIG. 7, the metallic element 734 can be formed with any suitable size (e.g., larger than the metallic element 634 shown in FIG. 6), including a size that forms all, or substantially all, of the matrix 730 and/or the inner matrix surface 732. While the dissimilar material is not limited to a metallic element, it will be referred to herein as a metallic element.

In the embodiment of the dental procedure device 700 shown in FIG. 7, the curved extension 750 can be at least partially formed from a dissimilar material such as a metal, ceramic, fabric, mesh composite or other polymer including films, dissolvable and/or retained materials and with the rest of the body 710 of the dental procedure device 700 (e.g., the upper member 720, the lower member 740, etc.) can be formed from a polymer or other non-metallic material (e.g., as described above with reference to FIGS. 1A-4). For example, the curved extension 750 can include a metallic element. However, as can be seen in FIG. 7, the metallic element 734 can be formed with any suitable size (e.g., larger than the metallic element 634 shown in FIG. 6), including a size that forms all, or substantially all, of the matrix 730 and/or the inner matrix surface 732. While the dissimilar material is not limited to a metallic element, it will be referred to herein as a metallic element.

In some embodiments, the metallic element 734 can include a rigid, or semi-rigid, piece of metal that is formed and/or shaped according to the inner matrix surface 732 as described in greater detail above (e.g., with a vertical and/or horizontal contour in the inner matrix surface 732 and/or the metallic element 734). The body 710 can include the metallic element 734 that is formed from a stamped piece of metallic material (e.g., steel and/or any other metal or metal alloy), with the upper member 720 and/or the lower member 740 formed from a polymer that is heat staked, over molded, or otherwise formed around, friction fit or adhered to the stamped piece of metallic material. For example, the portions of the body 710 formed from a polymer material (e.g., the upper and/or lower members 620, 640) may encompass, or be physically formed around, one or more sides, or edges, of the metallic element 734 (e.g., as shown in FIG. 7), which can extend to the lead in portion 744 at the tip of the body 710.

As described above, the metallic element 734 may increase the overall rigidity, flexibility, malleability, elasticity, and/or hardness of the body 710 and may prevent, and/or substantially reduce, unwanted deformation of the matrix 730, the inner matrix surface 732, and/or any other portion of the body 710 after insertion of the dental procedure device 700 between two adjacent teeth. Additionally, in some embodiments, the metallic element 734 may increase stiffness of the dental procedure device 700 for insertion but can also be configured to allow a user to deform or shape the metallic element 734 (e.g., burnish) to promote a tighter contact between the adjacent teeth between which the dental procedure device 700 may be inserted.

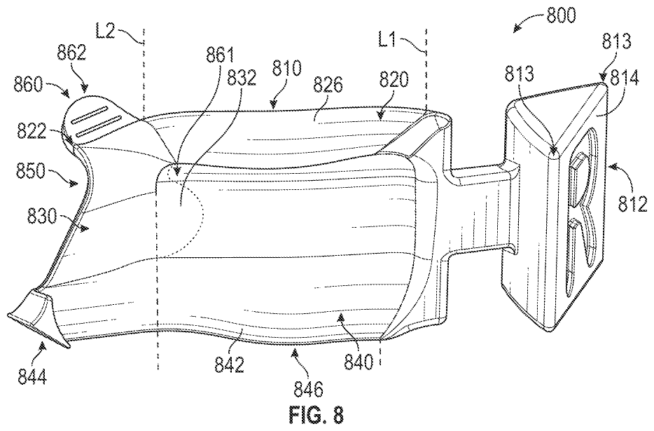

FIG. 8 is a front view of a dental procedure device 800, according to some embodiments. The dental procedure device 800 can include a body 810 and a handle 812 physically connected to the body 810. In some examples of the present disclosure, the body 810 and the handle 812 can be formed from the same material (e.g., a single continuous material), such as a polymer. However, in some examples, the body 810, or one or more portions thereof, and the handle 812 may be formed from one or more different materials (e.g., different polymers, metals, etc.).

The body 810 of the dental procedure device 800 can include an upper member 820, a matrix 830, and a lower member 840. As mentioned previously, the different portions of the body 810 can all be formed from a single material, such as a single continuous polymer. However, in some examples, the body 810 can include one or more components formed of one or more different materials. For example, the upper and/or lower members 820, 840 of the body 810 may each be formed from a polymer material that physically encompasses a metal material which can form at least a portion of the matrix 830 or other portion of the body 810 (e.g., as described in greater detail above, with reference to FIGS. 5-7.)

In some examples, the body 810 of the dental procedure device 800 includes a removable portion 860 of the body which can be detached during the dental procedure. The removable portion 860 may include a portion or all of the upper member 820, a portion or all of the matrix 830, and/or a portion or all of the lower member 840. The interface between the body 810 of the dental procedure device 800 and the removable portion 860 may include one or more features such as, but not limited to, tear line 861, a snap line, stress concentration features and/or an interface between materials to facilitate and control the detachment of the removable portion. Detachment of the removable portion may facilitate the removal of the dental procedure device from adjacent teeth or allow multiple dental procedure devices to be placed on the same tooth such as when a mesial and distal restoration is being performed of the same tooth, or in a core build up.

In some embodiments, the removable portion 860 of the body can include one or more features such as handle 862, loop or thru hole that is configured to interact with one or more tools (e.g., cotton pliers, hemostats, etc.) to assist in detaching the removable portion 860 from the body 810 of the dental procedure device 800.

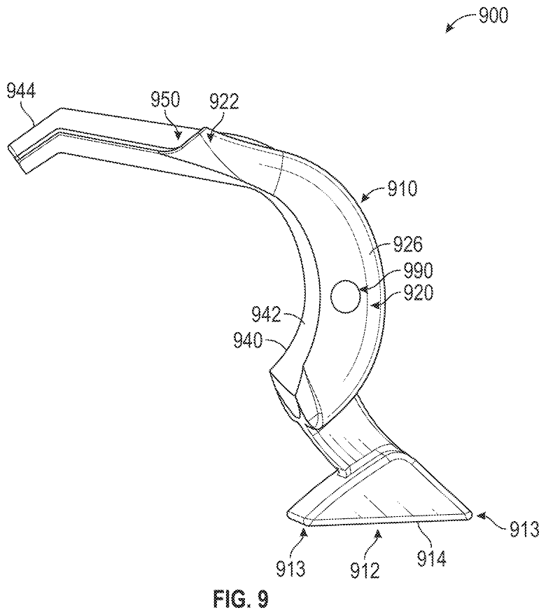

FIG. 9 is a top view of a dental procedure device 900, according to some embodiments. The dental procedure device 900 shown in FIG. 9 can include the body 910, the handle 912, the upper member 920, the upper wedge portion 922, the lower member 940, and the lead in portion 944. FIG. 9 illustrates a horizontal contour of the lower member 940 and of the upper member 920, which is curved in a region proximal to the handle 912 and that is substantially straight at a distal region of the lower member 940, which is proximate to, and/or forms part of, the lead in portion 944.

In some embodiments, the dental procedure device 900 can include a passage 990 (also referred to herein as a hole, aperture, channel, or the like) to allow one or more restorative materials used during a dental procedure to be passed through the dental procedure device 900 for adding or removing restorative materials during the dental procedure. Stated differently, the passage 990 may be configured to communicate one or more restorative materials through one or more portions of the dental procedure device 900 (e.g., through the upper member 920). Accordingly, the passage 990 may begin, end or traverse the body 910 (e.g., upper member 920, matrix 930, lower member 940, etc.) and/or handle 912 of the dental procedure device.

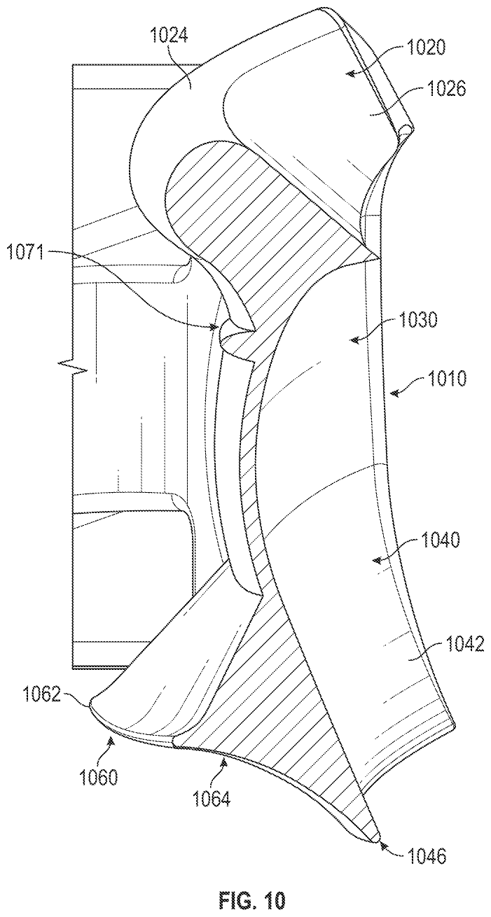

FIG. 10 is a cross section view of a dental procedure device 1000, according to some embodiments. FIG. 10 depicts a cross-sectional view of a dental procedure device 1000 at a center portion (e.g., at a point between line L1 and line L2 shown in FIG. 1A). As described above, the dental procedure device 1000 can include the body 1010, the upper member 1020, the matrix 1030, and the lower member 1040. The upper member 1020 can include the upper protrusion 1024 and the upper surface 1026.

In some examples, the upper member 1020 can be formed with a cross-sectional area configured to support one or more natural contours of a marginal ridge of a tooth during a dental procedure. Additionally, the upper member 1020 can include an upper surface 1026. The upper member 1020 can be configured, with the matrix 1030 and the lower member 1040, to facilitate and/or enable the separation of two adjacent teeth (e.g., the adjacent teeth 10 and 12 shown in FIG. 2) by the dental procedure device 1000. For example, the upper protrusion 1024 can be shaped and sized (e.g., extending vertically upward and backward, at an angle, with respect to the inner matrix surface 1032) to physically separate two adjacent teeth when the dental procedure device 1000 is inserted between them (e.g., with the device 1000 inserted as shown in FIG. 2).

The upper member 1020 may further facilitate and/or enable the device 1000 to separate the two adjacent teeth by physically supporting the lower member 1040, which may wedge or physically abut, one or more of the two adjacent teeth and thereby cause the lower member 1040 to remain engaged on, or in contact with, one or more of the teeth via a tension with the upper member 1020 and provided via the matrix 1030. More specifically, the body 1010 and each of the upper member 1020, the matrix 1030, and the lower member 1040 may be formed from one or more rigid and/or malleable materials. Accordingly, with the upper member 1020 abutting one or more of the two adjacent teeth, and physically connected to the lower member 1040 via a matrix 1030 (e.g., formed from a structural, rigid, semi-rigid, and/or malleable material), a tension can exist, via the matrix 1030, between the upper member 1020 and the lower member 1040 as a result of their respective positions between the two adjacent teeth.

In some embodiments, the matrix 1030 may include a substantially uniform cross-sectional area (e.g., a constant thickness), as shown in FIG. 10. However, in other embodiments, the matrix 1030 may include a non-uniform cross-sectional area, which is a cross-sectional area that may vary at one or more portions of the matrix 1030 (e.g., the matrix 1030 may have a varying thickness along the length and/or height of the body 1010). Stated differently, the matrix 1030 may, in some examples, include a horizontally and/or vertically varying thickness, which can differ at any point along the length and/or height of the matrix 1030 (e.g., the matrix 1030 may, in some examples, include two or more portions each with different thicknesses or cross-sectional areas).

The lower member 1040 can include the inner surface 1042, the downward protruding portion 1046, an outer element 1060 (e.g., formed in an outer surface of the dental procedure device), a crush rib 1062, and a curved lower surface 1064. The downward protruding portion 1046 can form part of a vertical contour of the inner surface 1042 of the lower member 1040. The lower member 1040 can be configured to control and confine restorative materials during a dental procedure (e.g., one or more resins and/or adhesives used during a dental restoration).

For example, the downward protruding portion 1046 may be formed in an arc or curved shape and the inner surface 1042 may change in size along one or more portions of the arc or curve of the downward protruding portion 1046 (e.g., the area of the inner surface 1042 may increase along a downward protruding portion 1046 from a region proximate to the handle 1012 to the greatest point in a curve formed by the downward protruding portion 1046). In some embodiments, the inner surface 1042 can include a curved lower surface (e.g., proximal to, and/or formed by, the downward protruding portion 1046), which can be configured, with the downward protruding portion 1046, to slide into a gingival sulcus of a tooth (e.g., between gingiva and the tooth 10 shown in FIG. 2) to separate a portion of gingiva from the tooth (e.g., the tooth 10 shown in FIG. 2) during a dental procedure and thereby prevent and/or reduce injury to that portion of gingiva during the dental procedure. The inner surface 1042 and/or the downward protruding portion 1046 can be configured to allow for restoration of deep caries, and prevent and/or reduce an amount of unwanted restoration material (e.g., restoration overhang) from being present outside an area or volume intended for a dental procedure (e.g., outside of a cavity in a tooth into which one or more dental restoration materials are deposited) by providing a physical space with a substantially uniform transition between the restorative material retained by the dental procedure device 1000 and the tooth receiving the dental procedure (e.g., providing a substantially smooth and/or uniform physical transition between restoration material and the tooth structure).

As described above, the inner surface 1042 can form a surface which is contoured vertically and horizontally. For example, the inner surface 1042 can include a contour (e.g., shape or profile) that varies vertically (e.g., from a bottom of the downward protruding portion 1046 up to the bottom of the matrix 1030). The downward protruding portion 1046 may also extend forward and away from a reference pane formed by the inner matrix surface 1032 (e.g., extending ‘out of the page’ or towards the viewer in the embodiment depicted in FIG. 1A). Accordingly, the lower member 1040 may include a three-dimensional contour, which may include one or more contours in the inner surface 1042 of the lower member.

Relatedly, the cross-sectional area of the lower member 1040 can change in size along the length of the body 1010 (e.g., increase and/or decrease in thickness along the length of the body from the lead in portion 1044 toward the handle 1012). For example, the cross-sectional area of the lower member 1040 can gradually increase and/or decrease in size along one or more portions of the lower member 1040 (e.g., increase in thickness while transversing a portion of the lower member 1040 from the lead in portion 1044 to the handle 1012). To give another, more specific, example, the cross-sectional area of the lower member 1040 may increase in one portion, decrease in another portion, then increase again in another distal portion of the lower member 1042 (e.g., a thickness that increases near the handle 1012, decreases in a mid-portion of the lower member 1040, and increase again towards the tip of the lower member 1040 and/or near the lead in portion 1044).

Stated differently, in some examples, the lower member 1040 can include one or more portions that have a thickness that is greater than a thickness of the matrix 1030 proximate to that portion of the lower member 1030 (e.g., at that same portion of the dental procedure device 1000). For example, the lower member 1040 may include two regions that are significantly thicker than the matrix 1030 (e.g., two or more regions with a cross-sectional area that is two or more times greater than the cross-sectional area of the matrix 1030), which may be separated by a third region of the lower member 1030 with a thickness that is greater than that of the matrix 1030 but less than that of the two regions that are significantly thicker than the matrix 1030 (e.g., 1.1 to 1.9 times the thickness, or cross-sectional area, of the matrix 1030). Accordingly, in some examples, one or more portions of the lower member 1030 may each include a cross-sectional area that is less than, equal to, or greater than, the cross-sectional area of the matrix 1030.

In some examples, the shape of the lower member 1040 can be configured to separate, or to aid in separating, two adjacent teeth to facilitate appropriate contact between the teeth after the completion of a dental procedure (e.g., after formation of a dental filling). However, in other embodiments, the lower member 1040 may include one or more portions with different cross-sectional shapes and it need not be limited to a triangular and/or V-shaped cross section. Accordingly, the lower member 1040 can include any suitable cross-sectional shape, including, for example, a triangular shape, a rectangular shape, a V-shape, a U-shape, a Y-shape, a W-shape a circular and/or semi-circular shape, and/or a polygonal shape. In addition, it may be rail shaped, split designed, fan shaped, wafer designed, honeycombed, wavy, beaded, chained, segmented, interrupted, hollow, solid, or filled. The shape may change direction, size and may utilize several shapes. The shape of the lower member 1040 may have retentive features such as bumps, rough teeth like protuberances, or various materials, adhesives, or expanding, absorbent, or inflatable materials to gain retention and/or separate the teeth.

In some embodiments, the crush rib 1062 can be configured to increase and/or enable a wedging force between the lower member 1040 and at least one of the two adjacent teeth, which can, as a result, enable and/or increase a gingival seal between the lower member 1040 and a tooth to receive the dental procedure (e.g., a tooth in which a dental filling may be formed). The gingival seal, or increase thereto, provided by the crush rib 1062 can contain and/or shape restoration materials during a dental procedure and may further prevent saliva or other liquids from flowing between the lower member 1040 and the tooth in which a dental restoration is performed (e.g., to prevent liquid from contacting the inner surface 1042, the tooth, and/or a restoration material used during a dental procedure).

In some embodiments, one or more crush ribs 1071 can be located at least partially on the upper member 1020 and/or at least partially on the matrix 1030 (as shown by 1071 in FIG. 10) and can be configured to increase and/or enable a wedging force between the upper member 1020 and/or the matrix 1030, and at least one of the two adjacent teeth, which can, as a result, enable and/or increase the buccal and lingual seal between the upper member 1020 and/or matrix 1030, and a tooth to receive the dental procedure (e.g., a tooth in which a dental filling may be formed). The buccal and lingual seals, or increase thereto, provided by the crush rib 1071 can contain and/or shape restoration materials during a dental procedure and may further prevent saliva or other liquids from flowing between the lower member 1040 and the tooth in which a dental restoration is performed (e.g., to prevent liquid from contacting the inner surface 1042, the tooth, and/or a restoration material used during a dental procedure).

In some embodiments, the gingiva-contacting surface 1064 can be configured to eliminate or reduce injury to the gingiva during insertion and removal of the dental restoration device, and/or during the dental procedure. For example, the gingiva-contacting surface may have a concave curvature which aides in separating the gingiva from the tooth while allowing the dental procedure device to slide overtop the gingiva without, or with minimal, pinching, cutting or abrading of the gingival tissue. However, in other embodiments, the gingiva-contacting surface 1064 may include one or more portions with different cross-sectional shapes and it need not be limited to a concave cross section. Accordingly, the gingiva-contacting surface 1064 can include any suitable cross-sectional shape, including, for example, a linear, a convex, a V-shape, a U-shape, a Y-shape, a W-shape, a circular and/or semi-circular shape, and/or a polygonal shape. In addition, it may be rail shaped, split designed, fan shaped, wafer designed, honeycombed, wavy, beaded, chained, segmented, interrupted, hollow, solid, or filled partly or fully with a dissimilar material. The shape may change direction, size and may utilize several shapes.

Some embodiments of a dental procedure device can comprise a body comprising: a matrix with an inner matrix surface, and a lower member providing a wedge shape and an inner surface that extends from a bottom portion of the inner matrix surface, wherein a dimension of the inner surface of the lower member gradually increases along a length of the lower member to provide a downward protruding portion; and a handle connected to the body at a first end of the body and extending from the body, wherein the lower member at least partially forms a tapered lead in portion at a second end of the body opposite the first end of the body coupled to the handle, the lead in configured to facilitate positioning of the dental procedure device.

In some embodiments of the dental procedure device the lower member can be configured to create a separation force between adjacent teeth during a dental procedure. In some embodiments, the dental procedure device can further comprise an upper member including a contoured inner surface and an upper wedge portion extending away from the contoured inner surface of the upper member, wherein the contoured inner surface is configured to abut an upper portion of a tooth. In some embodiments of the dental procedure device the upper member can further comprise an extension at the second end which curves away from the contoured inner surface. In one or more embodiments of the dental procedure device at least a portion of at least one of the matrix and the lower member can be configured to be detached. In some embodiments of the dental procedure device at least a portion of the upper member can be configured to be detached.

Additionally, in some embodiments of the dental procedure device the upper wedge portion of the upper member can extend away from the contoured inner surface at an obtuse angle. In one or more embodiments of the dental procedure device the upper member can be configured to support one or more natural contours in a marginal ridge of a tooth during a dental procedure.

In some embodiments of the dental procedure device, the inner matrix surface and the inner surface of the lower member can form a continuous surface configured to abut a tooth during a dental procedure. In some embodiments of the dental procedure device the inner matrix surface can be a contoured surface configured to control and confine restorative materials during a dental procedure. In one or more embodiments of the dental procedure device, a portion of the lower member can include a V-shaped cross-sectional area. And in some embodiments of the dental procedure device the lower member can further comprise a crush rib formed in an outer surface of the lower member, which can be configured to create a separation force between gingiva and dental material during a dental procedure. In some embodiments of the dental procedure device the body and handle can be formed from a single continuous material. Additionally, in some embodiments of the dental procedure device the matrix can be formed from a metal and the lower member can be formed from a plastic material.

In some embodiments of the dental procedure device, the matrix can include a uniform cross sectional area and wherein the inner matrix surface is configured to abut an upper region of a tooth during a dental procedure. Additionally, some embodiments of the dental procedure device can further include an upper member providing an inner surface to contour to an upper portion of a lateral surface of a tooth and including an upper wedge portion extending away from the inner surface, wherein the upper member is positioned at a top of the matrix.

In some embodiments of the dental procedure device a portion of at least one of the matrix, the lower member, and the upper member can be configured to be detached from the body while the dental procedure device is inserted between adjacent teeth. In some embodiments of the dental procedure device, the inner matrix surface can be configured to contour to a tooth surface to control and confine restorative materials during a dental procedure. In one or more embodiments of the dental procedure device a portion of the lower member can include a V-shaped cross-sectional area. And in some embodiments of the dental procedure device the lower member can further comprise a crush rib formed in an outer surface of the lower member, which is configured to create a separation force between adjacent teeth during a dental procedure.

In some of those embodiments of the dental procedure device the upper member can further comprise an extension disposed at the second end that curves away from the contoured inner surface of the upper member. In one or more embodiments of the dental procedure device the upper member can further comprise a passage configured to communicate restorative materials used during a dental procedure through the upper member during a dental procedure. In some embodiments of the dental procedure device the lead in portion can be formed by the lower member comprises a curved tip that curves toward the inner surface of the lower member and that is configured for initiating insertion of the body between two adjacent teeth.

Some embodiments of a dental procedure assembly, can comprise: a body comprising: a lower member with an inner surface and a protruding edge formed along at least a portion of the lower member and a matrix with an inner matrix surface that extends upward away from a top portion of the inner surface of the lower member, and a lead in portion disposed at a distal end of the body and at least partially formed by a distal portion of the lower member. In some of those embodiments, the dental procedure assembly can further comprise: a handle physically connected to the body at an end of the body opposite the lead in portion, wherein the handle includes at least one gripping surface. In some embodiments of the dental procedure device the lower member can further include a downward protruding portion that is configured to separate a portion of gingiva from a tooth during a dental procedure.

In some embodiments of the dental procedure assembly the lower member can include a varying cross-sectional area configured to provide, at insertion, a separation force between adjacent teeth during a dental procedure. And, in some embodiments of the dental procedure assembly the matrix can include a uniform cross-sectional area, and the inner matrix surface can be configured to abut one or more tooth surfaces, including subgingival tooth anatomy, during a dental procedure. In some embodiments of the dental procedure assembly the body can further comprise: an upper member with a cross-sectional area configured to support one or more natural contours in a marginal ridge of a tooth during a dental procedure.

In some embodiments of the dental procedure assembly a portion of the upper member can include a cross-sectional area configured to enable the portion of the upper member to physically support a position of the matrix during a dental procedure and provide an increased clamping force between the upper member and a tooth during a dental procedure. Additionally, in some embodiments of the dental procedure assembly the lower member can include a downward protruding frontal edge with a convex shape along at least a portion of the lower member. In one or more embodiments of the dental procedure assembly the downward protruding frontal edge can be configured to enable a portion of the lower member to support one or more natural contours of subgingival tooth anatomy. In one or more embodiments of the dental procedure assembly, the lead in portion can comprise an angled tip that extends away from the inner surface of the lower member at an obtuse angle.

Some embodiments of a dental procedure device can comprise: a body to be inserted to be disposed between two adjacent teeth, namely a treatment tooth and a neighboring tooth, the body comprising: a lower member providing a triangular wedge shape to separate the adjacent teeth as the lower member is inserted into position between the adjacent teeth, wherein the lower member provides an inner surface to contour to a lower portion of a lateral surface of the treatment tooth of the two adjacent teeth; a matrix extending upward from the lower member to, during utilization, be disposed between the treatment tooth and the adjacent tooth, the matrix providing an inner matrix surface to contour to the lateral surface of the treatment tooth; and
a handle at a proximal end of the body, the handle configured to be grasped by a user to insert the body into position between the adjacent teeth, wherein a distal portion of the matrix and a distal portion of the lower member together form a tapered lead in portion at a distal end of the body opposite the proximal end that is coupled to the handle, the lead in portion tapering to a tip configured to facilitate insertion of the body between the adjacent teeth. In one or more embodiments of the dental procedure device the tip can be a curved tip having a curvature towards the inner surface.

In some embodiments, the dental procedure device can further comprise an upper member providing an inner surface to contour to an upper portion of a lateral surface of a tooth and including an upper wedge portion extending away from the inner surface, wherein the upper member is positioned at a top of the matrix. In some embodiments of the dental procedure assembly the downward protruding frontal edge can be configured to enable a portion of the lower member to support one or more natural contours of subgingival tooth anatomy. And in some embodiments of the dental procedure assembly the convex shape can be configured to separate the gingiva from the tooth during a dental procedure. In one or more embodiments of the dental procedure device the upper member can further comprise an extension at the second end which curves away from the contoured inner surface.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B.’” Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The scope of the systems and methods described herein is thus indicated by the appended claims, rather than the foregoing description. The scope of the claims includes equivalents to the meaning and scope of the appended claims.

What is claimed is:

1. A dental procedure device, comprising:
a body comprising:
a matrix with an inner matrix surface, and
a lower member providing a wedge shape and an inner surface that extends from a bottom portion of the inner matrix surface, wherein a dimension of the inner surface of the lower member gradually increases along a length of the lower member to provide a downward protruding portion; and
a handle connected to the body at a first end of the body and extending from the body,
wherein the lower member at least partially forms a tapered lead in portion at a second end of the body opposite the first end of the body coupled to the handle, the lead in configured to facilitate positioning of the dental procedure device.

2. The dental procedure device of claim 1, further comprising:
an upper member including a contoured inner surface and an upper wedge portion extending away from the contoured inner surface of the upper member, wherein the contoured inner surface is configured to abut an upper portion of a tooth.

3. The dental procedure device of claim 2, wherein the upper wedge portion of the upper member extends away from the contoured inner surface at an obtuse angle.

4. The dental procedure device of claim 2, wherein the upper member is configured to support one or more natural contours in a marginal ridge of a tooth during a dental procedure.

5. The dental procedure device of claim 1, wherein a portion of at least one of the matrix, the lower member, and the upper member is configured to be detached from the body while the dental procedure device is inserted between adjacent teeth.

6. The dental procedure device of claim 1, wherein the inner matrix surface is configured to contour to a tooth surface to control and confine restorative materials during a dental procedure.

7. The dental procedure device of claim 1, wherein a portion of the lower member includes a V-shaped cross-sectional area.

8. The dental procedure device of claim 1, wherein the lower member further comprises a crush rib formed in an outer surface of the lower member, which is configured to create a separation force between adjacent teeth during a dental procedure.

9. The dental procedure device of claim 2, wherein the upper member further comprises an extension disposed at the second end that curves away from the contoured inner surface of the upper member.

10. The dental procedure device of claim 2, wherein the upper member further comprises a passage configured to communicate restorative materials used during a dental procedure through the upper member during a dental procedure.

11. The dental procedure device of claim 1, wherein the lead in portion formed by the lower member comprises a curved tip that curves toward the inner surface of the lower member and that is configured for initiating insertion of the body between two adjacent teeth.

12. A dental procedure assembly, comprising:
a body comprising:
a lower member with an inner surface and a protruding edge formed along at least a portion of the lower member and
a matrix with an inner matrix surface that extends upward away from a top portion of the inner surface of the lower member, and
a lead in portion disposed at a distal end of the body.

13. The dental procedure assembly of claim 12, further comprising:
a handle physically connected to the body at an end of the body opposite the lead in portion, wherein the handle includes at least one gripping surface.

14. The dental procedure device of claim 12, wherein the lower member further includes a downward protruding portion that is configured to separate a portion of gingiva from a tooth during a dental procedure.

15. The dental procedure assembly of claim 12, wherein the lower member includes a varying cross-sectional area configured to provide, at insertion, a separation force between adjacent teeth during a dental procedure.

16. The dental procedure assembly of claim 12, wherein the matrix includes a uniform cross-sectional area, and
wherein the inner matrix surface is configured to abut one or more tooth surfaces, including subgingival tooth anatomy, during a dental procedure.

17. The dental procedure assembly of claim 12, wherein the body further comprises:
an upper member with a cross-sectional area configured to support one or more natural contours in a marginal ridge of a tooth during a dental procedure.

18. The dental procedure assembly of claim 17, wherein a portion of the upper member includes a cross-sectional area configured to enable the portion of the upper member to physically support a position of the matrix during a dental procedure and provide an increased clamping force between the upper member and a tooth during a dental procedure.

19. The dental procedure assembly of claim 12, wherein the lower member includes a downward protruding frontal edge with a convex shape along at least a portion of the lower member.

20. The dental procedure assembly of claim 19, wherein the downward protruding frontal edge is configured to enable a portion of the lower member to support one or more natural contours of subgingival tooth anatomy.

21. The dental procedure assembly of claim 12, wherein the lead in portion comprises an angled tip that extends away from the inner surface of the lower member at an obtuse angle.

22. A dental procedure device, comprising:
a body to be inserted to be disposed between two adjacent teeth, namely a treatment tooth and a neighboring tooth, the body comprising:
a lower member providing a triangular wedge shaped to separate the adjacent teeth as the lower member is inserted into position between the adjacent teeth, wherein the lower member provides an inner surface to contour to a lower portion of a lateral surface of the treatment tooth of the two adjacent teeth;
a matrix extending upward from the lower member to, during utilization, be disposed between the treatment tooth and the adjacent tooth, the matrix providing an inner matrix surface to contour to the lateral surface of the treatment tooth; and
a handle at a proximal end of the body, the handle configured to be grasped by a user to insert the body into position between the adjacent teeth,
wherein a distal portion of the matrix and a distal portion of the lower member together form a tapered lead in portion at a distal end of the body opposite the proximal end that is coupled to the handle, the lead in portion tapering to a tip configured to facilitate insertion of the body between the adjacent teeth.

23. The dental procedure device of claim 22, further comprising:
an upper member providing an inner surface to contour to an upper portion of a lateral surface of a tooth and including an upper wedge portion extending away from the inner surface, wherein the upper member is positioned at a top of the matrix.
